(19) United States
(12) Patent Application Publication
(10) Pub. No.: US 2025/0259777 A1
(43) Pub. Date: Aug. 14, 2025

(54) INDUCTOR COMPONENT

(71) Applicant: Murata Manufacturing Co., Ltd., Kyoto-fu (JP)

(72) Inventors: Hideki KAMO, Nagaokakyo-shi (JP); Yoshimasa Yoshioka, Nagaokakyo-shi (JP); Tsuyoshi Takamatsu, Nagaokakyo-shi (JP)

(73) Assignee: Murata Manufacturing Co., Ltd., Kyoto-fu (JP)

(21) Appl. No.: 19/195,247

(22) Filed: Apr. 30, 2025

Related U.S. Application Data
(63) Continuation of application No. PCT/JP2023/030259, filed on Aug. 23, 2023.

(30) Foreign Application Priority Data
Nov. 2, 2022 (JP) 2022-176449

(51) Int. Cl. H01F 27/28; H01F 27/29; H01F 27/32; H01F 41/04; H01F 41/063

(52) U.S. Cl. CPC H01F 27/2804; H01F 27/2828; H01F 27/292; H01F 27/324; H01F 41/041; H01F 41/063; H01F 2027/2809

(57) ABSTRACT

An inductor component includes an element body having first and second principal surfaces opposite to each other; a coil that is in the element body and is wound in a spiral shape along an axis; and first and second external electrodes that are provided on the element body and are electrically connected to the coil. The axis of the coil is parallel to the first principal surface. The coil includes first coil wirings which are on the first principal surface side with respect to the axis and are arranged along the axis on a plane parallel to the first principal surface, second coil wirings which are on the second principal surface side with respect to the axis and are arranged along the axis on a plane parallel to the second principal surface.

### CROSS REFERENCE TO RELATED APPLICATION

This application claims benefit of priority to International Patent Application No. PCT/JP2023/030259, filed Aug. 23, 2023, and to Japanese Patent Application 2022-176449 filed Nov. 2, 2022, the entire content of each are incorporated herein by reference.

### BACKGROUND

### Technical Field

The present disclosure relates to an inductor component.

### Background Art

Conventionally, as an inductor component, there is an inductor component described in Japanese Patent No. 6652280. The inductor component includes an element body, a coil that is provided in the element body and is wound along an axial direction, and a first external electrode and a second external electrode that are provided on the element body and are electrically connected to the coil.

The coil has a plurality of coil patterns layered along an axis. The coil patterns adjacent to each other in the axial direction are connected via a conductive via. Each coil pattern includes a wiring portion extending in a direction orthogonal to the axis and a pad portion that is provided at an end portion of the wiring portion and is connected to the conductive via. A width of the pad portion is wider than a width of the wiring portion in order to improve the connectivity between the pad portion and the conductive via.

### SUMMARY

Incidentally, in the conventional inductor component, since the width of the pad portion is wider than the width of the wiring portion, a part of the pad portion is positioned on an inner side in a radial direction of the coil with respect to the wiring portion. Therefore, an inner diameter of the coil becomes small, and the efficiency of acquisition of inductance is not necessarily high.

In this regard, the present disclosure provides an inductor component capable of increasing the efficiency of acquisition of inductance.

Accordingly, one aspect of the present disclosure provides an inductor component comprising an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order, and the first penetration wirings and the second penetration wirings are not parallel to each other when viewed in the axial direction.

In this specification, the “axis” indicates an intersection line of a first plane passing through centers between the first coil wirings and the second coil wirings and a second plane passing through centers between the first penetration wirings and the second penetration wirings. That “the first penetration wirings and the second penetration wirings are not parallel to each other when viewed in the axial direction” indicates that a center line of the first penetration wiring and a center line of the second penetration wiring are not parallel to each other when viewed from the axial direction. Note that the center lines of the first penetration wiring and the second penetration wiring are lines passing through a center on a plane orthogonal to extending directions of the respective penetration wirings. That “the external electrode is provided on the element body” specifically indicates that the external electrode is provided on an outer surface side of the element body. For example, this includes a case where the external electrode is provided immediately on an outer surface of the element body, a case where the external electrode is provided on an outer side of the element body via an additional member on the element body, and a case where the external electrode is provided on the outer surface of the external electrode in a state where a part of the external electrode is embedded in the element body.

According to the aspect, since the coil includes the first coil wirings, the first penetration wirings, the second coil wirings, and the second penetration wirings, and each of the first coil wirings, each of the first penetration wirings, each of the second coil wirings, and each of the second penetration wirings form at least a part of the spiral shape by being connected in this order, it is possible to increase an inner diameter of the coil such that it is possible to increase the efficiency of acquisition of inductance. In addition, a Q value can be increased by increasing the efficiency of acquisition of inductance. Further, since the first penetration wirings and the second penetration wirings are not parallel to each other when viewed in the axial direction, it is possible to improve a degree of freedom in designing the first penetration wirings and the second penetration wirings, and for example, it is possible to increase the Q value or it is possible to increase the self-resonant frequency.

Preferably, in an embodiment of the inductor component, the first penetration wirings and the second penetration wirings are linearly symmetric with respect to the axis when viewed in a direction orthogonal to the first principal surface.

According to the embodiment, it is possible to secure symmetry with respect to the axis of the coil, and it is possible to easily design the coil.

Preferably, in the embodiment of the inductor component, the first penetration wirings and the second penetration wirings are linearly symmetric with respect to a straight line orthogonal to the first principal surface and including the axis when viewed in the axial direction.

According to the embodiment, it is possible to secure symmetry with respect to the axis of the coil, and it is possible to easily design the coil.

Preferably, in the embodiment of the inductor component, a line edge roughness of the first penetration wirings is higher than a line edge roughness of the first coil wirings.

Here, the line edge roughness of the first penetration wirings indicates the line edge roughness of a side surface on an inner diameter side of the coil, of side surfaces of each first penetration wiring, on a cross section orthogonal to the axis of the coil and including the center line of the first penetration wiring. The line edge roughness of the first coil wirings indicates the line edge roughness of a side surface of each first coil wiring on the cross section orthogonal to the first principal surface and including the center line of each first coil wiring.

According to the embodiment, adhesiveness between the first penetration wirings and the element body is improved by the anchor effect.

Preferably, in the embodiment of the inductor component, a line edge roughness of the first penetration wirings is equal to or lower than a line edge roughness of the first coil wirings.

According to the embodiment, since the side surfaces of the first penetration wirings are smooth, it is possible to reduce an increase in resistance at a high frequency due to a skin effect and to improve the Q value.

Preferably, in the embodiment of the inductor component, a width of each of the first penetration wirings is different from a width of each of the second penetration wirings.

Here, the width of the first penetration wiring is an equivalent circle diameter obtained from a cross-sectional area of the first penetration wiring on a cross section including a center of the first penetration wiring in the extending direction thereof and parallel to the first principal surface. The width of the second penetration wiring is an equivalent circle diameter obtained from a cross-sectional area of the second penetration wiring on a cross section including a center of the second penetration wiring in the extending direction thereof and parallel to the first principal surface.

According to the embodiment, it is possible to improve the degree of freedom in designing the first penetration wirings and the second penetration wirings.

Preferably, in the embodiment of the inductor component, the first penetration wirings have respective outer circumferential parts positioned on an outer side with respect to the first coil wirings and the second coil wirings in a radial direction of the coil when viewed in the axial direction, and the outer circumferential parts are disposed between 0.3 or more and 0.7 or less (i.e., from between 0.3 and 0.7) of a height of the element body with the first principal surface as a reference in the direction orthogonal to the first principal surface.

Here, being positioned on the outer side with respect to the first coil wirings and the second coil wirings in the radial direction of the coil indicates being positioned on an outer side with respect to a tangent line in the radial direction of the coil. The tangent line is in contact with an end surface of the first coil wiring positioned in the direction parallel to the first principal surface and an end surface of the second coil wiring positioned in the direction parallel to the first principal surface, when viewed in the axial direction.

According to the embodiment, since the first penetration wiring has the outer circumferential part, it is possible to increase the inner diameter of the coil such that it is possible to improve the Q value. In addition, since the outer circumferential part is disposed between 0.3 and 0.7 of the height of the element body, it is possible to provide the outer circumferential part only in a part of the height of the element body, thereby enabling a likelihood that the first penetration wiring will be exposed from the element body at the time of division into individual components to be decreased.

Preferably, the embodiment of the inductor component further comprises a second coil that is provided in the element body and is wound in a spiral shape along a second axis parallel to the axis; and a third external electrode and a fourth external electrode that are provided on the element body and are electrically connected to the second coil. The second coil includes a plurality of third coil wirings which are provided on the first principal surface side with respect to the second axis and are arranged along the second axis on a plane parallel to the first principal surface, a plurality of fourth coil wirings which are provided on the second principal surface side with respect to the second axis and are arranged along the second axis on a plane parallel to the second principal surface, a plurality of third penetration wirings which extend from the respective third coil wirings toward the respective fourth coil wirings and are arranged along the second axis, and a plurality of fourth penetration wirings which extend from the respective third coil wirings toward the respective fourth coil wirings, are provided on a side opposite to the respective third penetration wirings with respect to the second axis, and are arranged along the second axis. Each of the third coil wirings, each of the third penetration wirings, each of the fourth coil wirings, and each of the fourth penetration wirings form at least a part of a spiral shape of the second coil by being connected in this order, and the second penetration wirings and the third penetration wirings are adjacent to each other.

According to the embodiment, similarly to the coil, it is possible to increase the efficiency of acquisition of inductance and to improve the degree of freedom in design for the second coil.

Preferably, in the embodiment of the inductor component, the first penetration wirings and the second penetration wirings, and the third penetration wirings and the fourth penetration wirings are linearly symmetric with respect to a center line between the first coil and the second coil when viewed in the axial direction of the coil.

According to the embodiment, it is possible to easily obtain the first coil and the second coil having similar characteristics.

Preferably, in the embodiment of the inductor component, the second penetration wirings and the third penetration wirings are arranged parallel to each other, when viewed in the axial direction of the coil.

According to the embodiment, since the second penetration wirings and the third penetration wirings are arranged parallel to each other, it is possible to decrease a distance between the coil and the second coil adjacent to each other such that it is possible to decrease the size of the inductor component.

Preferably, in the embodiment of the inductor component, the first penetration wirings and the second penetration wirings are not linearly symmetric with respect to a straight line orthogonal to the first principal surface and including the axis when viewed in the axial direction.

According to the embodiment, since, in the first coil, the first penetration wirings and the second penetration wirings are not linearly symmetric with respect to the straight line orthogonal to the first principal surface and including the axis when viewed in the axial direction, it is possible to further improve the degree of freedom in designing the first penetration wirings and the second penetration wirings.

Preferably, in the embodiment of the inductor component, the third penetration wirings and the fourth penetration wirings are not parallel to each other when viewed in the second axial direction.

According to the embodiment, it is possible to increase a distance between each of the third penetration wirings and each of the fourth penetration wirings, and it is possible to increase an inner diameter of the second coil such that it is possible to improve the Q value.

Preferably, in the embodiment of the inductor component, the first penetration wirings have respective first connection surfaces connected to the respective first coil wirings and respective second connection surfaces connected to the respective second coil wirings. The first external electrode is provided on the first principal surface side, and overlaps at least a part of each of the first connection surfaces when viewed in the direction orthogonal to the first principal surface. Also, when viewed in the axial direction, an inclination angle on the axial side formed by a straight line connecting a center of each of the first connection surfaces and a center of each of the second connection surfaces and a connection surface of each of the second coil wirings connected to each of the first penetration wirings is 60° or larger and smaller than 90° (i.e., from 60° to smaller than 90°).

According to the embodiment, since the inclination angle is smaller than 90°, it is possible to decrease an area of the first coil wiring overlapping the first external electrode when viewed in the direction orthogonal to the first principal surface. Consequently, it is possible to decrease the parasitic capacitance between the first external electrode and the first coil wiring such that it is possible to increase the self-resonant frequency. In addition, since the inclination angle is 60° or larger, it is possible to secure the inner diameter of the coil such that it is possible to secure the Q value.

Preferably, in the embodiment of the inductor component, a part of each of the first connection surfaces and a part of each of the second connection surfaces overlap each other when viewed in the direction orthogonal to the first principal surface.

According to the embodiment, since a part of the first connection surface and a part of the second connection surface overlap each other when viewed in the direction orthogonal to the first principal surface, it is easy to form a seed layer in a case where a through-hole is formed in the element body, the seed layer is provided on an inner surface of the through-hole, and the first penetration wiring is formed on the seed layer by electrolytic plating.

Preferably, in the embodiment of the inductor component, the center of each of the first connection surfaces is closer to the axis than the center of each of the second connection surfaces is when viewed in the direction orthogonal to the first principal surface.

According to the embodiment, the first connection surface is disposed on an inner side with respect to the second connection surface of the coil when viewed in the direction orthogonal to the first principal surface. Consequently, it is possible to decrease the area of the first coil wiring overlapping the first external electrode when viewed in the direction orthogonal to the first principal surface, and it is possible to reduce the parasitic capacitance between the first external electrode and the first coil wiring such that it is possible to increase the self-resonant frequency.

Preferably, in the embodiment of the inductor component, each of the first penetration wirings includes a conductive layer positioned on an outer circumferential side when viewed in an extending direction of the first penetration wirings, and a non-conductive layer positioned inside the conductive layer.

According to the embodiment, since a current mainly flows in a surface of the first penetration wirings due to a skin effect in the case of use in a high frequency band, the Q value is not decreased by providing the conductive layer on the outer circumferential side. In addition, by providing the non-conductive layer inside, stress can be alleviated, and manufacturing costs can be reduced by using no conductor.

Preferably, in the embodiment of the inductor component, a cross-sectional area of at least one of both end portions of each of the first penetration wirings in the extending direction is larger than a cross-sectional area of a central portion of each of the first penetration wirings in the extending direction.

According to the embodiment, it is possible to increase the cross-sectional area of the end portion of the first penetration wiring such that connectivity between the first penetration wiring and at least one of the first coil wiring and the second coil wiring can be improved. In addition, when a hole portion is formed in the element body, the hole portion is filled with a conductive material by fill plating or the like, and the first penetration wiring is formed in the hole portion of the element body, it is easy to fill the hole portion on an opening side with the conductive material. Since the cross-sectional area of the end portion of the first penetration wiring is large, and the cross-sectional area of the central portion of the first penetration wiring is small, the first penetration wiring is easily formed.

Preferably, in the embodiment of the inductor component, the inductor component has a thickness of 200 μm or smaller.

According to the embodiment, it is possible to decrease a thickness of the inductor component.

Preferably, in the embodiment of the inductor component, when viewed in the direction orthogonal to the first principal surface, the first external electrode and the second external electrode are positioned on an inner side with respect to an outer surface of the element body.

According to the configuration, since the first external electrode and the second external electrode are not in contact with the outer surfaces of the element body, loads applied to the first external electrode and the second external electrode can be decreased, and deformation and peeling of the first external electrode and the second external electrode can be reduced, when division into individual inductor components is performed. Therefore, even if the inductor component has a small size, it is possible to prevent the first external electrode and the second external electrode from being deformed or peeled off.

Preferably, the embodiment of the inductor component further comprises an organic insulating body provided on the first principal surface. The element body is an inorganic insulating body, and the organic insulating body is positioned on an inner side with respect to an outer surface of the inorganic insulating body when viewed in the direction orthogonal to the first principal surface.

According to the embodiment, since the organic insulating body is provided, the organic insulating body easily imparts flowability, the organic insulating body easily fills a space between the first coil wirings adjacent to each other and enables insulating properties to be improved, in a case where the first coil wirings are covered with the organic insulating body. In addition, since the organic insulating body is not in contact with the outer surface of the inorganic insulating body, it is possible to decrease a load applied to the organic insulating body and reduce deformation and peeling of the organic insulating body when division into individual inductor components is performed.

According to the inductor component which is the one aspect of the present disclosure, it is possible to increase the efficiency of acquisition of inductance.

### BRIEF DESCRIPTION OF THE DRAWINGS

FIG. 1 is a schematic bottom view of an inductor component from a bottom surface side according to a first embodiment;

FIG. 2 is a cross-sectional view taken along line II-II in FIG. 1;

FIG. 3 is a cross-sectional view taken along line III-III in FIG. 1;

FIG. 4 is an enlarged view of a part of FIG. 2;

FIG. 5A is a schematic cross-sectional view illustrating a method for manufacturing an inductor component;

FIG. 5B is a schematic cross-sectional view illustrating the method for manufacturing an inductor component;

FIG. 5C is a schematic cross-sectional view illustrating the method for manufacturing an inductor component;

FIG. 5D is a schematic cross-sectional view for illustrating the method for manufacturing an inductor component;

FIG. 5E is a schematic cross-sectional view illustrating the method for manufacturing an inductor component;

FIG. 5F is a schematic cross-sectional view illustrating the method for manufacturing an inductor component;

FIG. 5G is a schematic cross-sectional view illustrating the method for manufacturing an inductor component;

FIG. 5H is a schematic cross-sectional view illustrating the method for manufacturing an inductor component;

FIG. 5I is a schematic cross-sectional view illustrating the method for manufacturing an inductor component;

FIG. 5J is a schematic cross-sectional view illustrating the method for manufacturing an inductor component;

FIG. 5K is a schematic cross-sectional view illustrating the method for manufacturing an inductor component;

FIG. 5L is a schematic cross-sectional view illustrating the method for manufacturing an inductor component;

FIG. 5M is a schematic cross-sectional view illustrating the method for manufacturing an inductor component;

FIG. 6A is a cross-sectional view showing a first modification example of the inductor component;

FIG. 6B is a cross-sectional view showing a second modification example of the inductor component;

FIG. 6C is a cross-sectional view showing a third modification example of the inductor component;

FIG. 6D is a cross-sectional view showing a fourth modification example of the inductor component;

FIG. 6E is a cross-sectional view showing a fifth modification example of the inductor component;

FIG. 7 is a schematic bottom view of an inductor component from a bottom surface side according to a second embodiment;

FIG. 8 is a cross-sectional view taken along line VIII-VIII in FIG. 7;

FIG. 9 is a partially enlarged view of FIG. 8;

FIG. 10A is a schematic cross-sectional view illustrating a method for manufacturing an inductor component;

FIG. 10B is a schematic cross-sectional view illustrating the method for manufacturing an inductor component;

FIG. 10C is a schematic cross-sectional view illustrating the method for manufacturing an inductor component;

FIG. 10D is a schematic cross-sectional view illustrating the method for manufacturing an inductor component;

FIG. 10E is a schematic cross-sectional view illustrating the method for manufacturing an inductor component;

FIG. 10F is a schematic cross-sectional view illustrating the method for manufacturing an inductor component;

FIG. 10G is a schematic cross-sectional view illustrating the method for manufacturing an inductor component;

FIG. 10H is a schematic cross-sectional view illustrating the method for manufacturing an inductor component;

FIG. 11A is a cross-sectional view showing a first modification example of the inductor component;

FIG. 11B is a cross-sectional view showing a second modification example of the inductor component;

### DETAILED DESCRIPTION

Hereinafter, an inductor component which is the one aspect of the present disclosure will be described in detail with reference to embodiments shown in the drawings. Note that the drawings include some schematic drawings, and may not reflect actual dimensions and ratios.

### First Embodiment

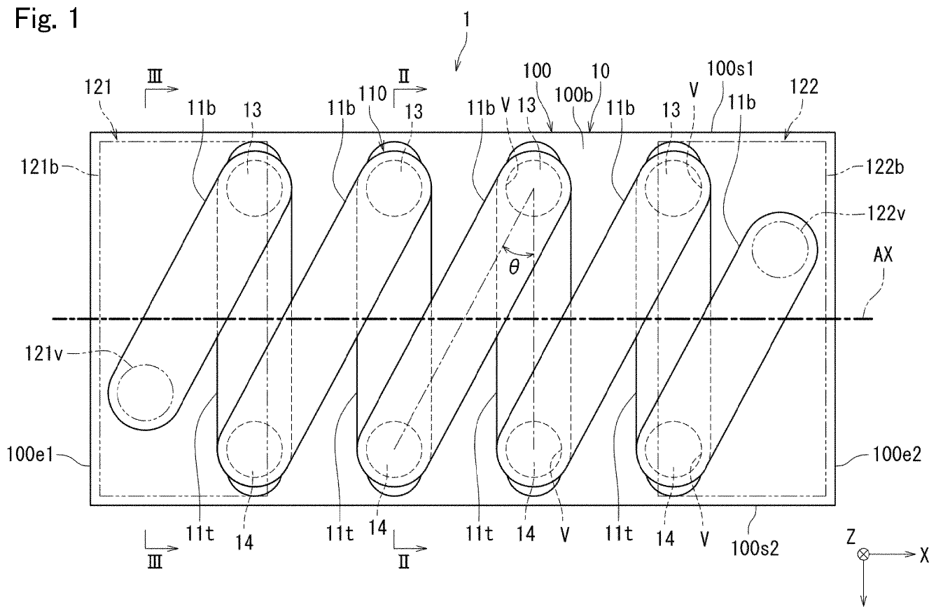

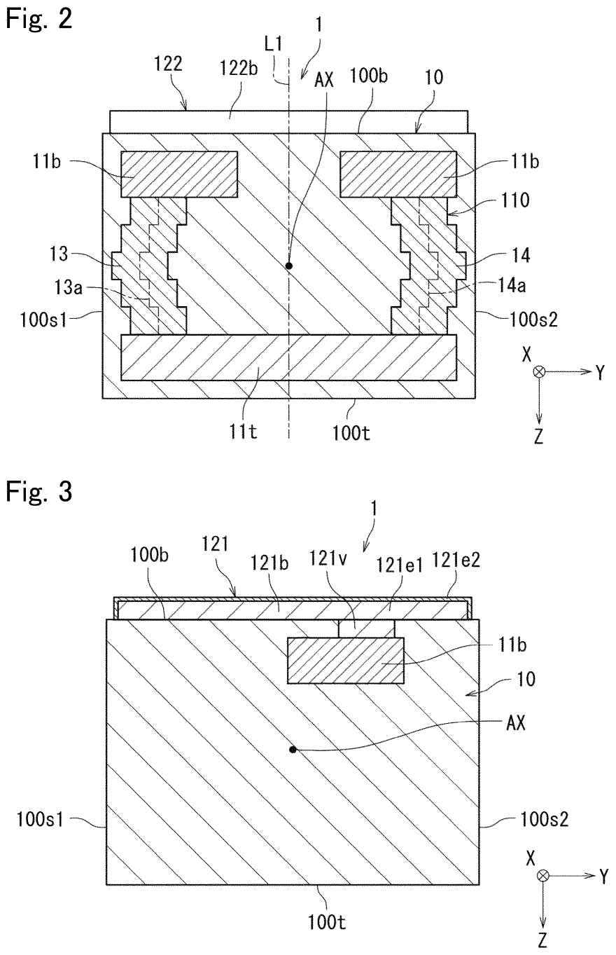

An inductor component 1 according to the first embodiment will be described below. FIG. 1 shows a schematic bottom view of the inductor component 1 from a bottom surface side thereof. FIG. 2 is a cross-sectional view taken along line II-II in FIG. 1. FIG. 3 is a cross-sectional view taken along line III-III in FIG. 1. Note that, in FIG. 1, an external electrode is drawn by a two-dot chain line for convenience. In addition, in FIG. 1, an element body 10 is drawn transparently so that a structure thereof can be easily understood, but may be translucent or opaque.

### 1. GENERAL CONFIGURATION

A general configuration of the inductor component 1 will be described. The inductor component 1 is, for example, a surface mount inductor component that is used in a high-frequency signal transmission circuit. As shown in FIGS. 1, 2, and 3, the inductor component 1 includes the element body 10, a coil 110 that is provided in the element body 10 and is wound in a spiral shape along an axis AX, and a first external electrode 121 and a second external electrode 122 that are provided on the element body 10 and are electrically connected to the coil 110.

The element body 10 has a length, a width, and a height. The element body 10 has a first end surface 100e1 and a second end surface 100e2 on both end sides in a length direction, a first side surface 100s1 and a second side surface 100s2 on both end sides in a width direction, and a bottom surface 100b and a top surface 100t on both end sides in a height direction. That is, outer surfaces 100 of the element body 10 include the first end surface 100e1 and the second end surface 100e2, the first side surface 100s1 and the second side surface 100s2, and the bottom surface 100b and the top surface 100t. The bottom surface 100b corresponds to an example of a “first principal surface” described in CLAIMS, and the top surface 100t corresponds to an example of a “second principal surface” described in CLAIMS.

As shown in the drawings, hereinafter, for convenience of description, a direction that is the length direction (longitudinal direction) of the element body 10 and is from the first end surface 100e1 toward the second end surface 100e2 is referred to as an X direction. In addition, a direction that is the width direction of the element body 10 and is from the first side surface 100s1 toward the second side surface 100s2 is referred to as a Y direction. In addition, a direction that is the height direction of the element body 10 and is from the bottom surface 100b toward the top surface 100t is referred to as a Z direction. The X direction, the Y direction, and the Z direction are directions orthogonal to each other and form a right-handed system when arranged in an order of X, Y, and Z.

In this specification, the “outer surfaces 100 of the element body” including the first end surface 100e1, the second end surface 100e2, the first side surface 100s1, the second side surface 100s2, the bottom surface 100b, and the top surface 100t of the element body 10 do not simply mean surfaces of the element body 10 toward the outer circumferential sides of the element body 10, but are surfaces serving as a boundary between an outside and an inside of the element body 10. In addition, “above the outer surfaces 100 of the element body 10” does not indicate an absolute direction such as a vertical upward direction defined in the direction of gravity, but indicates a direction toward the outside with the outer surfaces 100 as a reference, of the outside and inside with the outer surfaces 100 as the boundary therebetween. Hence, “above the outer surfaces 100” indicates a relative direction determined depending on an orientation of the outer surfaces 100. In addition, “above” with respect to a certain element means not only above from the corresponding element, that is, an upper position via another object on the corresponding element or an upper position apart from the corresponding element at an interval, but also a position immediately on the corresponding element to be in contact with the corresponding element.

The axis AX of the coil 110 is disposed parallel to the bottom surface 100b. The coil 110 includes a plurality of bottom surface wirings 11b which are provided on the bottom surface 100b side with respect to the axis AX and are arranged along the axis AX on a plane parallel to the bottom surface 100b, a plurality of top surface wirings 11t which are provided on the top surface 100t side with respect to the axis AX and are arranged along the axis AX on a plane parallel to the top surface 100t, a plurality of first penetration wirings 13 which extend from the respective bottom surface wirings 11b toward the respective top surface wirings 11t, and are arranged along the axis AX, and a plurality of second penetration wirings 14 which extend from the respective bottom surface wirings 11b toward the respective top surface wirings 11t, are provided on a side opposite to the respective first penetration wirings 13 with respect to the axis AX, and are arranged along the axis AX. Each of the bottom surface wirings 11b, each of the first penetration wirings 13, each of the top surface wirings 11t, and each of the second penetration wirings 14 form at least a part of a spiral shape by being connected in this order.

The bottom surface wiring 11b corresponds to an example of a “first coil wiring” described in CLAIMS, and the top surface wiring 11t corresponds to an example of a “second coil wiring” described in CLAIMS. The axis AX indicates an intersection line of a first plane passing through centers between the bottom surface wirings 11b and the top surface wirings 11t and a second plane passing through centers between the first penetration wirings 13 and the second penetration wirings 14. That is, the axis AX is a straight line passing through a center of an inner diameter portion of the coil 110. The axis AX of the coil 110 does not have a dimension in a direction orthogonal to the axis AX.

According to the configuration described above, since the coil 110 includes the bottom surface wirings 11b, the first penetration wirings 13, the top surface wirings 11t, and the second penetration wirings 14, and each of the bottom surface wirings 11b, each of the first penetration wirings 13, each of the top surface wirings 11t, and each of the second penetration wirings 14 form at least a part of the spiral shape by being connected in this order, it is possible to increase an inner diameter of the coil 110 such that it is possible to increase the efficiency of acquisition of inductance. In addition, a Q value can be increased by increasing the efficiency of acquisition of inductance.

To be more specific, since pad portions of a conventional inductor component or the bottom surface wirings 11b and the top surface wirings 11t of the present embodiment are “reception portions” of wirings (conductive vias of the conventional inductor component or the first penetration wirings 13 and the second penetration wirings 14 of the present embodiment) which penetrate an element body, the pad portions and the bottom and top surface wirings have a shape expanding perpendicularly to a direction in which to penetrate the element body. Here, in a configuration of the conventional inductor component, since the conductive vias extend in a direction parallel to an axis of a coil, the pad portions are expanded in a direction perpendicular to the axis of the coil and are likely to have a structure in which magnetic flux generated in an axial direction of the coil is blocked.

On the other hand, in the present embodiment, since the first penetration wiring 13 and the second penetration wiring 14 extend in a direction perpendicular to the axis AX of the coil 110, the bottom surface wiring 11b and the top surface wiring 11t are expanded in a direction parallel to the axis AX of the coil 110. Accordingly, it is difficult for the bottom surface wiring 11b and the top surface wiring 11t to have a structure in which magnetic flux generated in an axis AX direction is blocked. That is, according to the present embodiment, it is possible to have the structure in which it is difficult to block the magnetic flux such that it is possible to improve the efficiency of acquisition of inductance and the Q value.

As shown in FIG. 2, the first penetration wiring 13 and the second penetration wiring 14 are not parallel to each other when viewed in the axis AX direction. That is, a center line 13a of the first penetration wiring 13 and a center line 14a of the second penetration wiring 14 are not parallel to each other when viewed in the axis AX direction.

According to the configuration described above, since the first penetration wiring 13 and the second penetration wiring 14 are not parallel to each other when viewed in the axis AX direction, it is possible to improve the degree of freedom in designing the first penetration wiring 13 and the second penetration wiring 14, and for example, it is possible to increase the Q value or it is possible to increase the self-resonant frequency. To be more specific, it is possible to increase a distance between the first penetration wiring 13 and the second penetration wiring 14, and it is possible to increase the inner diameter of the coil 110 such that it is possible to improve the Q value.

Note that it is preferable that all the first penetration wirings 13 and all the second penetration wirings 14 are not parallel to each other when viewed in the axis AX direction. At least one first penetration wiring 13 and at least one second penetration wiring 14 may not be parallel to each other when viewed in the axis AX direction. It is preferable that the first penetration wirings 13 and the second penetration wirings 14 intersecting the same plane orthogonal to the axis AX are not parallel to each other when viewed in the axis AX direction. In addition, although all the first penetration wirings 13 overlap each other when viewed in the axis AX direction, of all the first penetration wirings 13, some first penetration wirings 13 that do not overlap when viewed in the axis AX direction may be provided. The same applies to the second penetration wirings 14.

### 2. CONFIGURATIONS OF RESPECTIVE UNITS

### (Inductor Component 1)

A volume of the inductor component 1 is 0.08 mm³ or smaller, and a size of a long side of the inductor component 1 is 0.65 mm or smaller. The size of the long side of the inductor component 1 indicates the largest value of a length, a width, and a height of the inductor component 1, and in this embodiment, indicates the length in the X direction. According to the configuration described above, since the volume of the inductor component 1 is small and the long side of the inductor component 1 is short, a weight of the inductor component 1 is reduced. Therefore, even if the external electrodes 121 and 122 are small, necessary mounting strength can be obtained. In addition, a thickness of the inductor component 1 is preferably 200 μm or smaller. This enables a thin inductor component 1 to be obtained.

To be more specific, the size (length (X direction)×width (Y direction)×height (Z direction)) of the inductor component 1 is 0.6 mm×0.3 mm×0.3 mm, 0.4 mm×0.2 mm×0.2 mm, 0.25 mm×0.125 mm×0.120 mm, or the like. In addition, the width and the height may not be equal, and may be, for example, 0.4 mm×0.2 mm×0.3 mm.

### (Element Body 10)

The element body 10 contains SiO₂. This enables insulation properties and stiffness to be imparted to the element body 10. The element body 10 is made of, for example, a glass sintered body. The glass sintered body may contain alumina, and the strength of the element body can be further increased.

The glass sintered body is formed by, for example, layering insulating layers containing a plurality of types of glass. A layering direction of the plurality of insulating layers is the Z direction. That is, the insulating layer has a layer shape having a principal surface expanding on an X-Y plane. Note that, in the element body 10, an interface between the plurality of insulating layers may not be distinct due to firing or the like.

Note that the element body 10 may include, for example, a glass substrate. The glass substrate may be a single-layer glass substrate, and since most of the element body is made of glass, it is possible to reduce a loss such as an eddy current loss at a high frequency.

### (Coil 110)

The coil 110 includes the plurality of bottom surface wirings 11b, the plurality of top surface wirings 11t, the plurality of first penetration wirings 13, and the plurality of second penetration wirings 14. The bottom surface wirings 11b, the first penetration wirings 13, the top surface wirings 11t, and the second penetration wirings 14 are connected in this order, respectively, to constitute at least a part of the coil 110 wound in the axis AX direction.

According to the configuration described above, since the coil 110 is a so-called helical coil 110, in a cross section orthogonal to the axis AX, it is possible to reduce a region where the bottom surface wiring 11b, the top surface wiring 11t, the first penetration wiring 13, and the second penetration wiring 14 are laid out parallel to each other in a winding direction of the coil 110, and it is possible to reduce stray capacitance in the coil 110.

Here, the helical shape indicates a shape in which the number of turns of the entire coil is more than one turn, and the number of turns of the coil in the cross section orthogonal to the axis is less than one turn. One or more turns indicate a state in which the wirings of the coil have, on the cross section orthogonal to the axis, parts that are adjacent to each other in a radial direction and are laid out parallel to each other in the winding direction when viewed in an axial direction, and less than one turn indicates a state in which the wirings of the coil does not have, on the cross section orthogonal to the axis, parts that are adjacent to each other in the radial direction and are laid out parallel to each other in the winding direction when viewed in the axial direction.

The bottom surface wirings 11b extend only in one direction. To be more specific, the bottom surface wirings 11b slightly tilt in the X direction and extend in the Y direction. All the bottom surface wirings 11b are arranged parallel to each other in the X direction. Here, in a photolithography process, when deformed illumination such as annular illumination or dipole illumination is used, pattern resolution in a specific direction can be enhanced to form a finer pattern. According to the configuration described above, since the bottom surface wirings 11b extend only in one direction and all the bottom surface wirings 11b are arranged parallel to each other, it is possible to form the fine bottom surface wirings 11b and reduce the size of the inductor component 1 by using, for example, modified illumination in a photolithography process.

The top surface wirings 11t extend only in one direction. To be more specific, the top surface wirings 11t have a shape extending in the Y direction. All the top surface wirings 11t are arranged parallel to each other in the X direction. According to the configuration described above, since the top surface wirings 11t extend only in one direction and all the top surface wirings 11t are arranged parallel to each other, it is possible to form the fine top surface wirings 11t and reduce the size of the inductor component 1 by using, for example, modified illumination in a photolithography process.

The bottom surface wirings 11b and the top surface wirings 11t are made of a good conductor material such as copper, silver, gold, or an alloy thereof. The bottom surface wirings 11b and the top surface wirings 11t may be a metal film formed by plating, vapor deposition, sputtering, or the like, or may be a metal sintered body obtained by applying and sintering a conductor paste. In addition, the bottom surface wirings 11b and the top surface wirings 11t may have a multilayer structure in which a plurality of metal layers are layered. The bottom surface wirings 11b and the top surface wirings 11t have a thickness of preferably 5 μm or more and 50 μm or less (i.e., from 5 μm to 50 μm).

The first penetration wirings 13 are disposed in through-holes V of the element body 10 on the first side surface 100s1 side with respect to the axis AX, and the second penetration wirings 14 are disposed in the other through-holes V of the element body 10 on the second side surface 100s2 side with respect to the axis AX. Each of the first penetration wirings 13 and the second penetration wirings 14 extends in a direction orthogonal to the bottom surface 100b and the top surface 100t. This enables lengths of the first penetration wirings 13 and the second penetration wirings 14 to be shortened, thus enabling the direct current resistance (Rdc) to be reduced. The first penetration wirings 13 and the second penetration wirings 14 are all arranged parallel to each other in the X direction.

The first penetration wiring 13 and the second penetration wiring 14 are not parallel to each other when viewed in the axis AX direction. To be more specific, the first penetration wiring 13 and the second penetration wiring 14 are bent at respective centers thereof in the Z direction such that a space therebetween is widened toward the centers. That is, each of the first penetration wiring 13 and the second penetration wiring 14 has a shape expanding outward in a radial direction of the coil 110 toward the center in the Z direction. In addition, each of the first penetration wiring 13 and the second penetration wiring 14 has a stepped shape in the Z direction. According to the configuration described above, in a case where the first penetration wiring 13 and the second penetration wiring 14 are each formed by layering a plurality of conductor layers, the first penetration wiring 13 and the second penetration wiring 14 can be easily formed in the stepped shape by shifting and layering each conductor layer.

Preferably, as shown in FIG. 1, the first penetration wiring 13 and the second penetration wiring 14 are linearly symmetric with respect to the axis AX when viewed in the direction orthogonal to the bottom surface 100b. This enables symmetry with respect to the axis AX of the coil 110 to be secured, thus enabling the coil 110 to be easily designed. In addition, it is possible to decrease entry of a part of the penetration wiring into an inner side of the inner diameter of the coil 110 and improve the Q value.

Preferably, as shown in FIG. 2, the first penetration wiring 13 and the second penetration wiring 14 are linearly symmetric with respect to a straight line L1 orthogonal to the bottom surface 100b and including the axis AX when viewed in the axis AX direction. This enables symmetry with respect to the axis AX of the coil 110 to be secured, thus enabling the coil 110 to be easily designed. In addition, it is possible to decrease entry of a part of the penetration wiring into an inner side of the inner diameter of the coil 110 and improve the Q value.

Preferably, a line edge roughness (hereinafter, also referred to as LER) of the first penetration wiring 13 is higher than a line edge roughness of the bottom surface wiring 11b. To be more specific, the line edge roughness of the first penetration wiring 13 indicates the line edge roughness of a side surface on an inner diameter side of the coil 110, of side surfaces of the first penetration wiring 13, on a cross section orthogonal to the axis AX of the coil 110 and including the center line 13a of the first penetration wiring 13. The line edge roughness of the bottom surface wiring 11b indicates the line edge roughness of a side surface of the bottom surface wiring 11b on a cross section orthogonal to the bottom surface 100b and including a center line 14a of the bottom surface wiring 11b. This causes adhesiveness between the first penetration wirings 13 and the element body 10 to be improved by the anchor effect.

The LER of the first penetration wiring 13 indicates dimensional deviations of a width of the first penetration wiring 13. The width of the first penetration wiring 13 is a dimension in a direction orthogonal to the center line 13a on a cross section including the center line 13a of the first penetration wiring 13. A method of measuring the LER is in accordance with the SEMI standard (SEMI Standard P47-0307, Test Method for Evaluation of Line-Edge Roughness and Line width Roughness). In the present embodiment, an SEM image (or an optical image) of the first penetration wiring 13 is acquired at a magnification at which ⅓ or more of a length of the first penetration wiring 13 in an extending direction thereof is taken, and the LER of the first penetration wiring 13 is calculated using WinROOF 2018 which is image processing software. Similarly, regarding the bottom surface wiring 11b, an SEM image of the bottom surface wiring 11b is acquired at a magnification at which ⅓ or more of a length of the bottom surface wiring 11b in an extending direction thereof is taken, and the LER of the bottom surface wiring 11b is calculated. Note that, unless otherwise specified, the LER in the present specification indicates an average value of LERs calculated at three or more points on an image acquired as described above, and the three or more calculation points include at least two points at an interval which is half or more of the acquired image.

Similarly, the line edge roughness of the first penetration wirings 13 may be higher than the line edge roughness of the top surface wirings 11t, and adhesiveness between the first penetration wirings 13 and the element body 10 is improved by the anchor effect. Similarly, the line edge roughness of the second penetration wirings 14 may be higher than the line edge roughness of the bottom surface wirings 11b, and adhesiveness between the second penetration wirings 14 and the element body 10 is improved by the anchor effect. Similarly, the line edge roughness of the second penetration wirings 14 may be higher than the line edge roughness of the top surface wirings 11t, and adhesiveness between the second penetration wirings 14 and the element body 10 is improved by the anchor effect.

Here, the line edge roughness of the first penetration wirings 13 may be equal to or lower than the line edge roughness of the bottom surface wirings 11b. This enables an increase in resistance at a high frequency due to a skin effect to be reduced and to improve the Q value since the side surfaces of the first penetration wirings 13 are smooth. Similarly, the line edge roughness of the first penetration wirings 13 may be equal to or lower than the line edge roughness of the top surface wirings 11t. Similarly, the line edge roughness of the second penetration wirings 14 may be equal to or lower than the line edge roughness of the bottom surface wirings 11b, and since the side surfaces of the second penetration wirings 14 are smooth, it is possible to reduce an increase in resistance at a high frequency due to the skin effect and to improve the Q value. Similarly, the line edge roughness of the second penetration wirings 14 may be equal to or lower than the line edge roughness of the top surface wirings 11t.

Preferably, the width of the first penetration wiring 13 is different from the width of the second penetration wiring 14. The width of the first penetration wiring 13 is an equivalent circle diameter obtained from a cross-sectional area of the first penetration wiring 13 on a cross section including a center of the first penetration wiring 13 in the extending direction thereof and parallel to the bottom surface 100b. The width of the second penetration wiring 14 is an equivalent circle diameter obtained from a cross-sectional area of the second penetration wiring 14 on a cross section including a center of the second penetration wiring 14 in the extending direction thereof and parallel to the bottom surface 100b. To be more specific, the first penetration wiring 13 is divided into three equal portions of an upper portion, a middle portion, and a lower portion in a height direction thereof, and an average value of the equivalent circle diameters of cross-sectional areas of the three equal portions is defined as the width. Note that, in a case where the width of the first penetration wiring 13 and the width of the second penetration wiring 14 are relatively different by 10% or more, it is assumed that the width of the first penetration wiring 13 and the width of the second penetration wiring 14 are different.

According to the configuration described above, it is possible to improve the degree of freedom in designing the first penetration wirings 13 and the second penetration wirings 14. For example, when a penetration wiring is inclined or curved, the DC resistance increases. Hence, a width of the penetration wiring on a side on which a line length is long is increased so that DC resistances of penetration wirings having different shapes and different line lengths are the same.

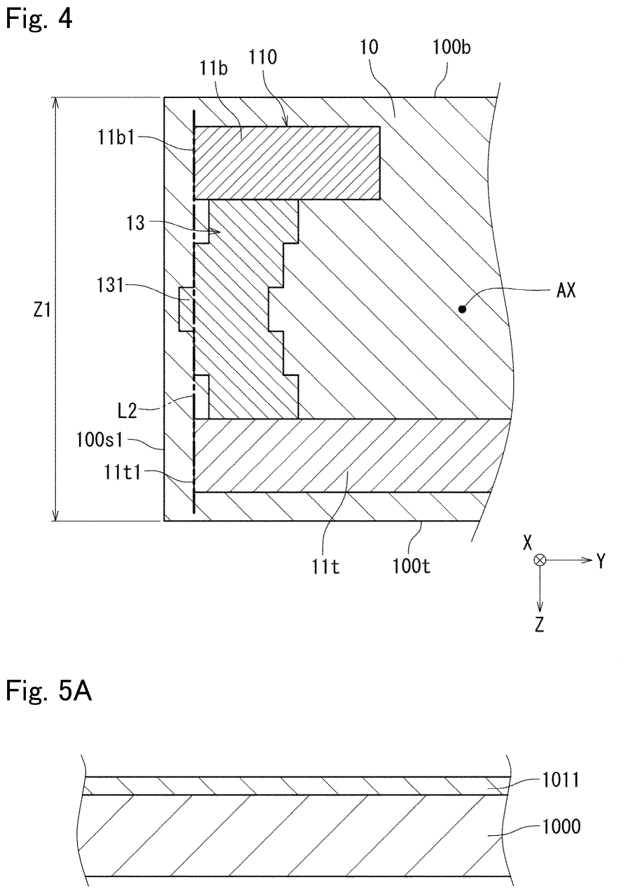

FIG. 4 is an enlarged view of a part of FIG. 2. As shown in FIG. 4, the first penetration wirings 13 have respective outer circumferential parts 131 positioned on an outer side with respect to the bottom surface wirings 11b and the top surface wirings 11t in a radial direction of the coil 110 when viewed in the axis AX direction. When viewed in the axis AX direction, the outer circumferential part 131 is positioned on the outer side with respect to a tangent line L2 in the radial direction of the coil 110. The tangent line L2 is in contact with an end surface 11b1 of the bottom surface wiring 11b positioned in the direction parallel to the bottom surface 100b and an end surface 11t1 of the top surface wiring 11t positioned in the direction parallel to the bottom surface 100b. The outer circumferential part 131 is disposed between 0.3 or more and 0.7 or less (i.e., from 0.3 to 0.7) of a height Z1 with the bottom surface 100b as a reference in the direction orthogonal to the bottom surface 100b of the element body 10. The height Z1 of the element body 10 is a distance from the bottom surface 100b to the top surface 100t. A position of 1.0 of the height Z1 of the element body 10 corresponds to the top surface 100t.

According to the configuration described above, since the first penetration wiring 13 has the outer circumferential part 131, it is possible to increase the inner diameter of the coil 110 such that it is possible to improve the Q value. In addition, since the outer circumferential part 131 is disposed between 0.3 or more and 0.7 or less (i.e., from 0.3 to 0.7) of the height Z1 of the element body, it is possible to provide the outer circumferential part 131 only in a part of the height Z1 of the element body 10, thereby enabling a likelihood that the first penetration wiring 13 will be exposed from the element body 10 at the time of division into individual components to be decreased.

Similarly, the second penetration wirings 14 have respective outer circumferential parts positioned on an outer side with respect to the bottom surface wirings 11b and the top surface wirings 11t in the radial direction of the coil 110 when viewed in the axis AX direction, and the outer circumferential part is disposed between 0.3 or more and 0.7 or less (i.e., from 0.3 to 0.7) of the height Z1 of the element body 10. Consequently, it is possible to increase the inner diameter of the coil 110 such that it is possible to improve the Q value, and it is possible to decrease a likelihood that the second penetration wiring 14 will be exposed from the element body 10 at the time of division into individual components.

Preferably, the first penetration wirings 13 contain SiO₂. This enables a linear expansion coefficient of the first penetration wiring 13 to be equal to a linear expansion coefficient of the element body 10 in a case where the element body 10 contains SiO₂, thus enabling cracks between the first penetration wirings 13 and the element body 10 to be reduced. The first penetration wiring 13 is made of, for example, a conductive paste. A conductive material is Ag, Cu, or the like. Similarly, the second penetration wirings 14 preferably contain SiO₂.

Preferably, as shown in FIG. 2, when viewed in the direction orthogonal to the bottom surface 100b, the first end portion of the bottom surface wiring 11b and the first end portion of the top surface wiring 11t overlap each other, and an angle θ formed by the bottom surface wiring 11b and the top surface wiring 11t is an acute angle. The angle θ is an angle between a center line (a chain line in FIG. 2) of a width of the bottom surface wiring 11b and a center line (a chain line in FIG. 2) of a width of the top surface wiring 11t when viewed in the direction orthogonal to the bottom surface 100b.

Preferably, as shown in FIG. 2, when viewed in the direction orthogonal to the bottom surface 100b, the angle θ formed by the bottom surface wiring 11b and the top surface wiring 11t connected to the same first penetration wiring 13 is 5° or larger and 45° or smaller (i.e., from 5° to 45° or smaller). The angle θ is an angle between a center line (a chain line in FIG. 2) of a width of the bottom surface wiring 11b and a center line (a chain line in FIG. 2) of a width of the top surface wiring 11t when viewed in the direction orthogonal to the bottom surface 100b.

According to the configuration described above, since the coils 110 are densely wound, it is possible to improve the inductance. Since the angle θ is 45° or smaller, a coil length is shortened, the leakage flux is reduced, and the Q value is increased. The coil length indicates an interval between both end parts positioned on the outermost sides in the axis AX direction, among the bottom surface wirings 11b, the top surface wirings 11t, the first penetration wirings 13, and the second penetration wirings 14. Since the angle θ is 5° or larger, it is possible to decrease possibilities that the two first penetration wirings 13 adjacent to each other in the axis AX direction are brought into contact with each other, and it is possible to decrease possibilities that the two second penetration wirings 14 adjacent to each other in the axis AX direction are brought into contact with each other. Of all the bottom surface wirings 11b and the top surface wirings 11t, the angle θ between at least one set of the bottom surface wiring 11b and the top surface wiring 11t may be 5° or larger and 45° or smaller (i.e., from 5° to 45° or smaller).

Preferably, similarly when viewed in the direction orthogonal to the bottom surface 100b, the angle θ formed by the bottom surface wiring 11b and the top surface wiring 11t connected to the same second penetration wiring 14 is 5° or larger and 45° or smaller (i.e., from 5° to) 45°. Consequently, since the coils 110 are densely wound, it is possible to improve the inductance.

Preferably, at least one wiring of the bottom surface wirings 11b, the top surface wirings 11t, the first penetration wirings 13, and the second penetration wirings 14 includes a void portion or a resin portion. This enables stress due to a difference in linear expansion coefficient between the wiring and the element body 10 to be absorbed by the void portion or the resin portion, thus enabling the stress to be alleviated. As a method of forming the void portion, for example, the void portion can be formed by sintering a wiring, by using a member which is burned into the material of the wiring by being sintered. As a method for forming the resin portion, for example, the resin portion can be formed by using a conductive paste in the material of the wiring.

Preferably, at least one wiring of the bottom surface wirings 11b and the top surface wirings 11t contains SiO₂. This enables a linear expansion coefficient of the wiring to be equal to the linear expansion coefficient of the element body 10 in a case where the element body 10 contains SiO₂, thus enabling cracks between the wiring and the element body 10 to be reduced.

### (First External Electrode 121 and Second External Electrode 122)

The first external electrode 121 is connected to the first end portion of the coil 110, and the second external electrode 122 is connected to the second end portion of the coil 110. The first external electrode 121 is provided on the first end surface 100e1 side with respect to a center of the element body 10 in the X direction to be exposed from the outer surface 100 of the element body 10. The second external electrode 122 is provided on the second end surface 100e2 side with respect to a center of the element body 10 in the X direction to be exposed from the outer surface 100 of the element body 10.

When viewed in the direction orthogonal to the bottom surface 100b, the first external electrode 121 and the second external electrode 122 are positioned on an inner side with respect to the outer surface 100 of the element body 10. That is, the first external electrode 121 and the second external electrode 122 are positioned on an inner side with respect to the first end surface 100e1, the second end surface 100e2, the first side surface 100s1, and the second side surface 100s2 of the element body 10.

According to the configuration described above, since the first external electrode 121 and the second external electrode 122 are not in contact with the outer surfaces 100 of the element body 10, loads applied to the first external electrode 121 and the second external electrode 122 can be decreased, and deformation and peeling of the first external electrode 121 and the second external electrode 122 can be reduced, when division into individual inductor components is performed. Therefore, even if the inductor component has a small size, it is possible to prevent the first external electrode 121 and the second external electrode 122 from being deformed or peeled off.

Note that the first external electrode 121 may be provided to be continuously connected to the bottom surface 100b and the first end surface 100e1. This enables a solder fillet to be formed on the first external electrode 121 when the inductor component 1 is mounted on a mounting substrate, since the first external electrode 121 is a so-called L-shaped electrode. Similarly, the second external electrode 122 may be provided to be continuously connected to the bottom surface 100b and the second end surface 100e2.

The first external electrode 121 has a bottom surface part 121b provided on the bottom surface 100b and a via part 121v embedded in the bottom surface 100b. The via part 121v is connected to the bottom surface part 121b. The via part 121v is connected to an end portion of the bottom surface wiring 11b positioned on the first end surface 100e1 side in the axis AX direction.

The second external electrode 122 has a bottom surface part 122b provided on the bottom surface 100b and a via part 122v embedded in the bottom surface 100b. The via part 122v is connected to the bottom surface part 122b. The via part 122v is connected to an end portion of the bottom surface wiring 11b positioned on the second end surface 100e2 side in the axis AX direction.

The first external electrode 121 has a base layer 121e1 and a plating layer 121e2 covering the base layer 121e1. The base layer 121e1 contains, for example, a conductive material such as Ag or Cu. The plating layer 121e2 contains, for example, a conductive material such as Ni or Sn. A part of the bottom surface part 121b and the via part 121v are formed by the base layer 121e1. The other part of the bottom surface part 121b is formed by the plating layer 121e2. Similarly, the second external electrode 122 has a base layer and a plating layer covering the base layer. Note that the first external electrode 121 and the second external electrode 122 may be made of a single-layer conductor material.

### (Method for Manufacturing Inductor Component 1)

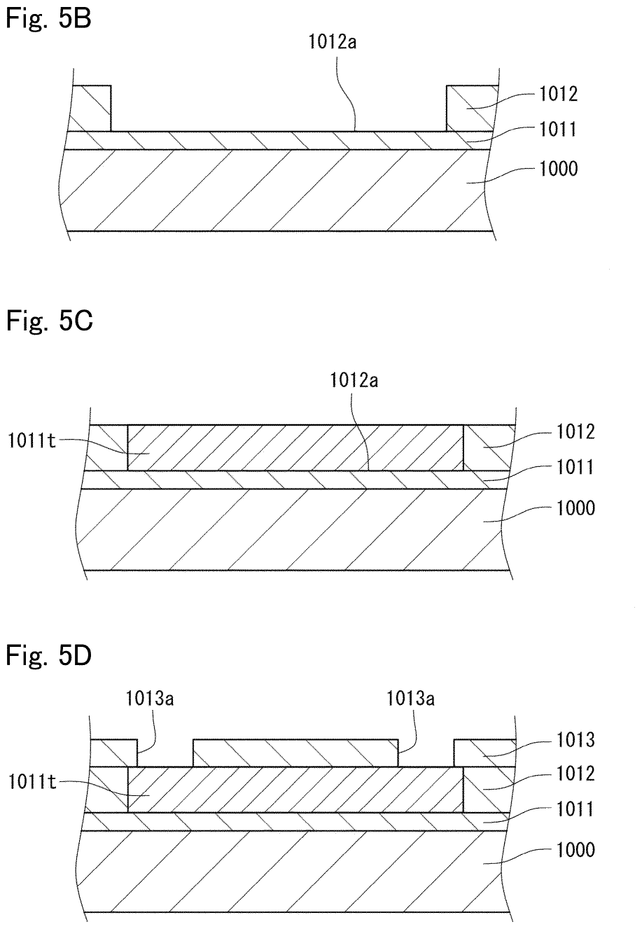

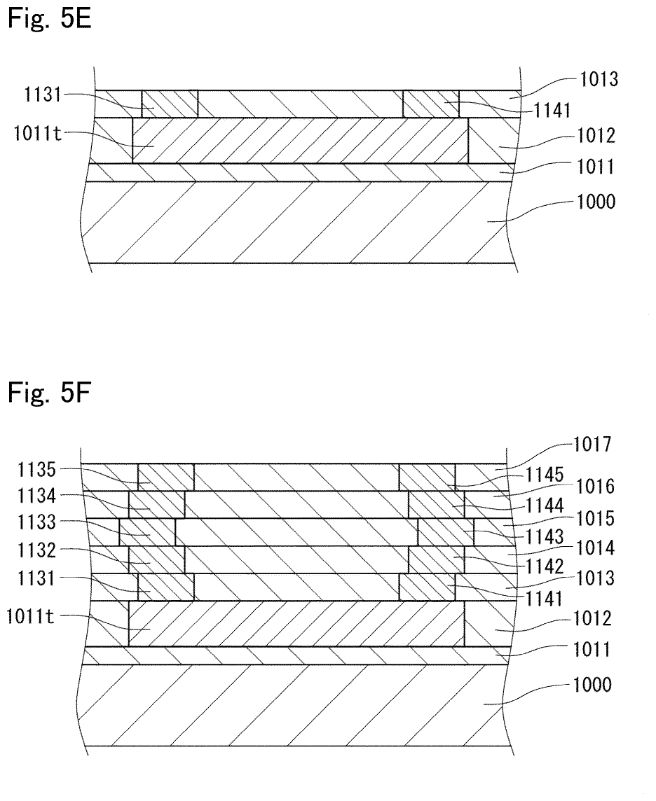

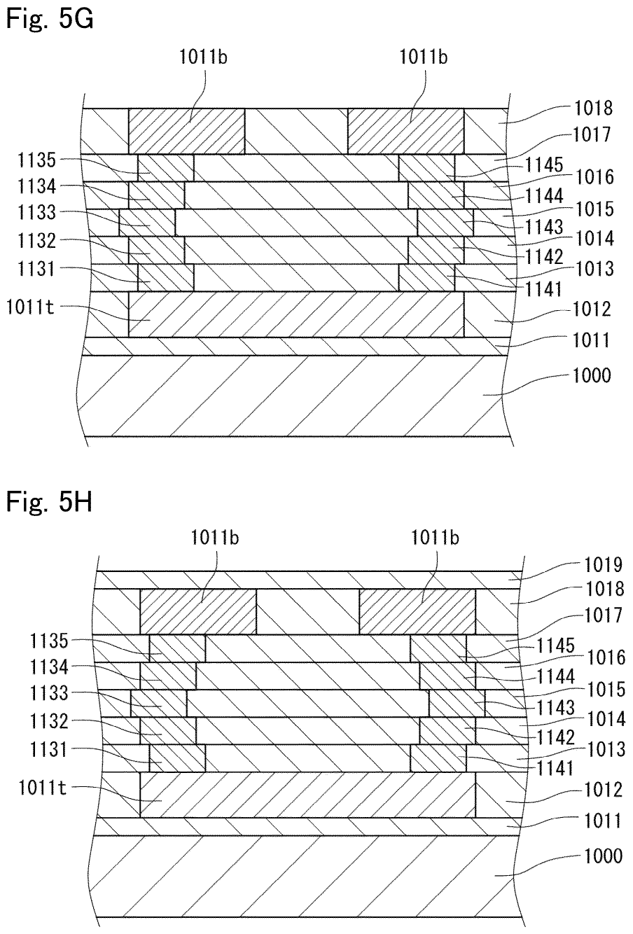

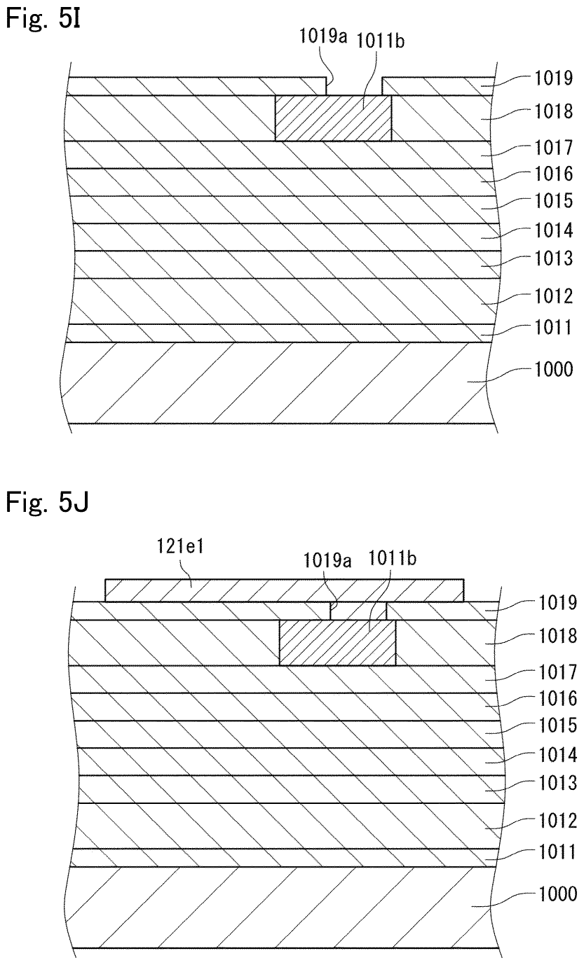

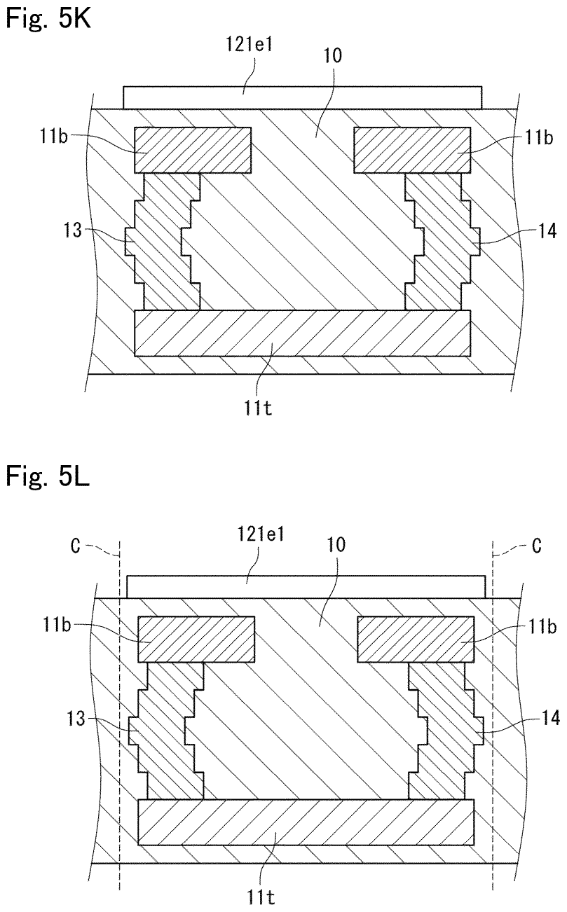

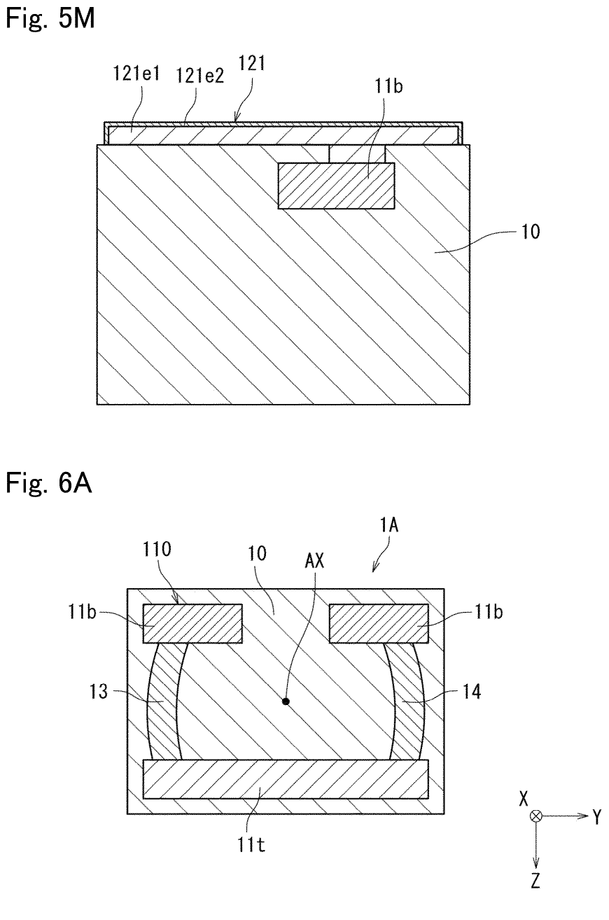

Next, a method for manufacturing the inductor component 1 will be described with reference to FIGS. 5A to 5M. FIGS. 5A to 5H, 5K, and 5L are views corresponding to a cross section taken along line II-II in FIG. 1. FIGS. 5I, 5J, and 5M are views corresponding to a cross section taken along line III-III in FIG. 1.

As shown in FIG. 5A, a first insulating layer 1011 is printed on a base substrate 1000. Examples of materials of the base substrate 1000 include a glass substrate, a silicon substrate, an alumina substrate, or the like, and examples of materials of the first insulating layer 1011 include a resin such as epoxy or polyimide, or an inorganic insulating film such as SiO or SiN.

As shown in FIG. 5B, a second insulating layer 1012 is printed on the first insulating layer 1011. A groove 1012a is provided in the second insulating layer 1012. In this case, for example, the groove 1012a is formed by the photolithography process. Note that the groove may be formed as a printed pattern from the beginning.

As shown in FIG. 5C, a top surface conductor layer 1011t is printed in the groove 1012a. Examples of materials of the top surface conductor layer 1011t include Ag, Cu, Au, Al, an alloy containing at least one of these elements, or a solder paste. In this case, for example, the top surface conductor layer 1011t is formed as a printed pattern to remain only in the groove 1012a. Note that, after the top surface conductor layer 1011t is printed on the second insulating layer 1012, the top surface conductor layer 1011t may remain only in the groove 1012a by the photolithography process.

As shown in FIG. 5D, a third insulating layer 1013 is printed on the second insulating layer 1012. The third insulating layer 1013 has a first groove 1013a and a second groove 1013b. The first groove 1013a and the second groove 1013b are formed in the same method as described in FIG. 5B.

As shown in FIG. 5E, a first penetration conductor layer 1131 as a first layer is printed in the first groove 1013a, and a second penetration conductor layer 1141 as the other first layer is printed in the second groove 1013b. The first penetration conductor layer 1131 as the first layer and the second penetration conductor layer 1141 as the other first layer are formed by the same method described in FIG. 5C.

By repeating the above-described processes, as shown in FIG. 5F, a fourth insulating layer 1014 is provided on the third insulating layer 1013, and a first penetration conductor layer 1132 as a second layer and a second penetration conductor layer 1142 as the other second layer are provided in two respective grooves provided in the fourth insulating layer 1014. Further, a fifth insulating layer 1015 is provided on the fourth insulating layer 1014, and a first penetration conductor layer 1133 as a third layer and a second penetration conductor layer 1143 as the other third layer are provided in two respective grooves provided in the fifth insulating layer 1015. Further, a sixth insulating layer 1016 is provided on the fifth insulating layer 1015, and a first penetration conductor layer 1134 as a fourth layer and a second penetration conductor layer 1144 as the other fourth layer are provided in two respective grooves provided in the sixth insulating layer 1016. Further, a seventh insulating layer 1017 is provided on the sixth insulating layer 1016, and a first penetration conductor layer 1135 as a fifth layer and a second penetration conductor layer 1145 as the other fifth layer are provided in two respective grooves provided in the seventh insulating layer 1017.

In this case, the first penetration conductor layer 1131 as the first layer, the first penetration conductor layer 1132 as the second layer, and the first penetration conductor layer 1133 as the third layer are sequentially layered to be shifted outward in the radial direction of the coil, and the first penetration conductor layer 1133 as the third layer, the first penetration conductor layer 1134 as the fourth layer, and the first penetration conductor layer 1135 as the fifth layer are sequentially layered to be shifted inward in the radial direction of the coil. In this case, the second penetration conductor layer 1141 as the other first layer, the second penetration conductor layer 1142 as the other second layer, and the second penetration conductor layer 1143 as the other third layer are sequentially layered to be shifted outward in the radial direction of the coil, and the second penetration conductor layer 1143 as the other third layer, the second penetration conductor layer 1144 as the other fourth layer, and the second penetration conductor layer 1145 as the other fifth layer are sequentially layered to be shifted inward in the radial direction of the coil.

As shown in FIG. 5G, an eighth insulating layer 1018 is provided on the seventh insulating layer 1017, and a bottom surface conductor layer 1011b is provided in a groove provided in the eighth insulating layer 1018. A material of the bottom surface conductor layer 1011b is the same as the material of the top surface conductor layer 1011t. As shown in FIG. 5H, a ninth insulating layer 1019 is provided on the eighth insulating layer 1018.

As shown in FIG. 5I, a groove 1019a is provided in the ninth insulating layer 1019 such that a part of the bottom surface conductor layer 1011b is exposed. As shown in FIG. 5J, a base conductor layer 1121e1 is provided on the ninth insulating layer 1019 and in the groove 1019a. Examples of materials of the base conductor layer 1121e1 include resin pastes of Ag or Cu.

As shown in FIG. 5K, an entire layered body is sintered in a furnace at a high temperature (for example, 500° C. or higher). The first to ninth insulating layers 1011 to 1019 are sintered to form the element body 10, the top surface conductor layer 1011t is sintered to form the top surface wiring 11t, the bottom surface conductor layer 1011b is sintered to form the bottom surface wiring 11b, the first penetration conductor layers 1131 to 1135 as the first to fifth layers are sintered to form the first penetration wiring 13, the second penetration conductor layers 1141 to 1145 as the first to fifth other layers are sintered to form the second penetration wiring 14, and the base conductor layer 1121e1 is sintered to form the base layer 121e1. Hence, it is possible to improve the strength by sintering the insulating layers, and a resin component which does not need to be contained in the conductor layers can be volatilized by sintering the conductor layers, and a conductor material contained in the conductor layers can be fused to realize high conductivity. The base substrate 1000 may be peeled off by decomposing a surface during sintering, may be mechanically removed by performing grinding or the like before and after the sintering, or may be chemically removed by performing etching or the like before and after the sintering.

As shown in FIG. 5L, division into individual inductor components is performed along a cutting line C. As shown in FIG. 5M, the plating layer 121e2 is formed by performing barrel plating to cover the base layer 121e1, and the first external electrode 121 is formed. Consequently, as shown in FIG. 2, the inductor component 1 is manufactured.

### 3. MODIFICATION EXAMPLES

### First Modification Example

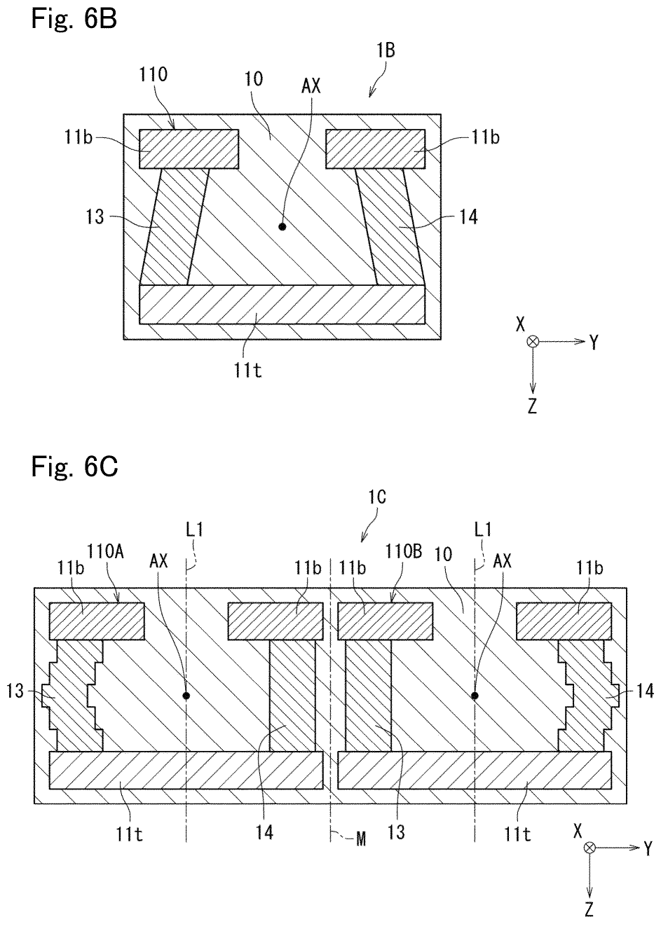

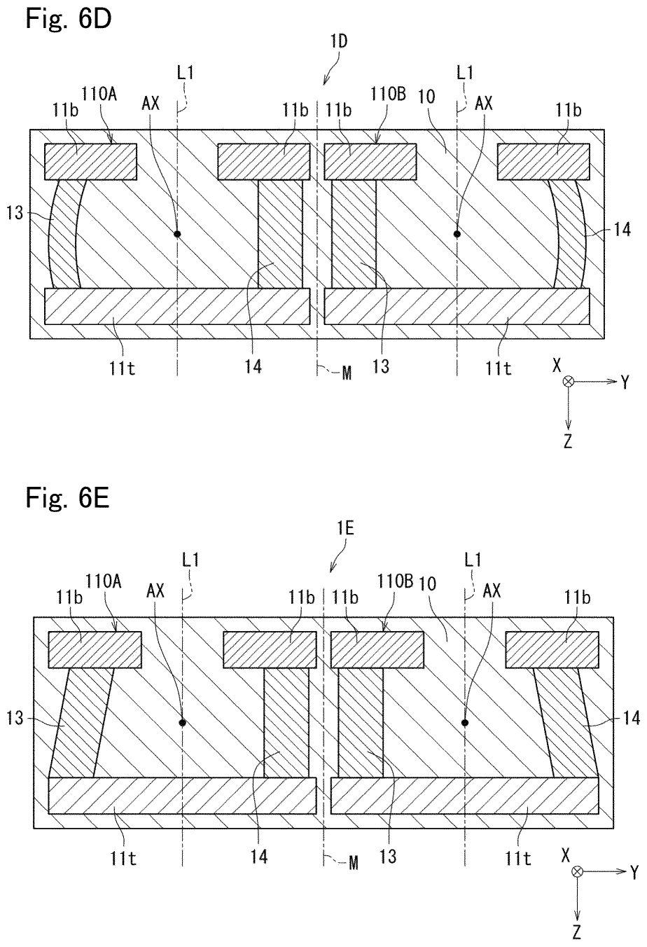

FIG. 6A is a view showing a first modification example of the inductor component, and the view corresponds to the cross section taken along line II-II in FIG. 1. As shown in FIG. 6A, in an inductor component 1A of the first modification example, the first penetration wiring 13 and the second penetration wiring 14 are not parallel to each other when viewed in the axis AX direction. This enables a distance between the first penetration wiring 13 and the second penetration wiring 14 to be increased and enables the inner diameter of the coil 110 to be increased such that it is possible to improve the Q value.

To be more specific, the first penetration wiring 13 and the second penetration wiring 14 are bent at respective centers thereof in the Z direction such that a space therebetween is widened toward the centers. That is, each of the first penetration wiring 13 and the second penetration wiring 14 has a shape expanding outward in a radial direction of the coil 110 toward the center in the Z direction.

In addition, each of the first penetration wiring 13 and the second penetration wiring 14 has an arc shape in the Z direction. That is, the inner-side surface of the first penetration wiring 13 has a concave curved surface, and the outer-side surface of the first penetration wiring 13 has a convex curved surface. The inner-side surface of the second penetration wiring 14 has a concave curved surface, and the outer-side surface of the second penetration wiring 14 has a convex curved surface. The inner-side surfaces of both the first penetration wiring 13 and the second penetration wiring 14 are surfaces on the inner diameter side of the coil 110, and the outer-side surfaces of both the first penetration wiring 13 and the second penetration wiring 14 are surfaces on the outer diameter side of the coil 110.

According to the configuration described above, the inner-side surfaces of both the first penetration wirings 13 and the second penetration wirings 14 and the outer-side surfaces of both the first penetration wirings 13 and the second penetration wirings 14 can be made smooth such that it is possible to decrease the DC resistance. In particular, since the inner-side surfaces of both the first penetration wirings 13 and the second penetration wirings 14 are smooth, it is possible to reduce an increase in resistance at a high frequency due to the skin effect and to improve the Q value.

### Second Modification Example

FIG. 6B is a view showing a second modification example of the inductor component, and the view corresponds to the cross section taken along line II-II in FIG. 1. As shown in FIG. 6B, in an inductor component 1B of the second modification example, the first penetration wiring 13 and the second penetration wiring 14 are not parallel to each other when viewed in the axis AX direction. This enables a distance between the first penetration wiring 13 and the second penetration wiring 14 to be increased and enables the inner diameter of the coil 110 to be increased such that it is possible to improve the Q value.

To be more specific, the first penetration wirings 13 and the second penetration wirings 14 are inclined such that a space therebetween is widened toward the top surface wiring 11t side in the Z direction. That is, each of the first penetration wirings 13 and the second penetration wirings 14 has a shape expanding outward in the radial direction of the coil 110 toward the top surface wiring 11t in the Z direction. As described above, the coil 110 has a trapezoidal shape when viewed from the axis AX direction.

According to the configuration described above, the first penetration wirings 13 and the second penetration wirings 14 can be linearly formed and shortened, and the DC resistance of the first penetration wirings 13 and the second penetration wirings 14 can be reduced.

### Third Modification Example

FIG. 6C is a view showing a third modification example of the inductor component, and the view corresponds to the cross section taken along line II-II in FIG. 1. As shown in FIG. 6C, an inductor component 1C of the third modification example includes a first coil 110A and a second coil 110B as compared with the inductor component 1 shown in FIG. 2. The first coil 110A corresponds to the coil 110 of the inductor component 1 shown in FIG. 2.

Similarly to the first coil 110A, the second coil 110B is provided in the element body 10, is spirally wound along the axis AX (an example of a second axis), and is connected to a third external electrode and a fourth external electrode (not shown). The third external electrode and the fourth external electrode have the same configurations as those of the first external electrode 121 and the second external electrode 122 of the inductor component 1 shown in FIG. 1.

Similarly to the first coil 110A, the second coil 110B includes a bottom surface wiring 11b (an example of a third coil wiring), a top surface wiring 11t (an example of a fourth coil wiring), a first penetration wiring 13 (an example of a third penetration wiring), and a second penetration wiring 14 (an example of a fourth penetration wiring).

In the first coil 110A, the first penetration wiring 13 and the second penetration wiring 14 are not parallel to each other when viewed in the axis AX direction. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1 in FIG. 2. Meanwhile, the second penetration wiring 14 has a linear shape parallel to the Z direction. That is, the first penetration wiring 13 is bent at a center thereof in the Z direction such that a space between the first penetration wiring 13 and the second penetration wiring 14 is widened toward the center. The first penetration wiring 13 has a stepped shape in the Z direction. According to the configuration described above, in a case where the first penetration wiring 13 is formed by layering a plurality of conductor layers, the first penetration wiring 13 can be easily formed in the stepped shape by shifting and layering each conductor layer.

In the second coil 110B, the first penetration wiring 13 and the second penetration wiring 14 are not parallel to each other when viewed in the axis AX direction. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1 in FIG. 2. Meanwhile, the first penetration wiring 13 has a linear shape parallel to the Z direction. That is, the second penetration wiring 14 is bent at a center thereof in the Z direction such that a space between the first penetration wiring 13 and the second penetration wiring 14 is widened toward the center. The second penetration wiring 14 has a stepped shape in the Z direction. According to the configuration described above, in a case where the second penetration wiring 14 is formed by layering a plurality of conductor layers, the second penetration wiring 14 can be easily formed in the stepped shape by shifting and layering each conductor layer.

Preferably, as illustrated in FIG. 6C, the axis AX of the first coil 110A and the axis AX of the second coil 110B are arranged parallel to each other. When viewed in the axis AX direction of the first coil 110A, the first penetration wiring 13 and the second penetration wiring 14 of the first coil 110A and the first penetration wiring 13 and the second penetration wiring 14 of the second coil 110B are linearly symmetric with respect to a center line M between the first coil 110A and the second coil 110B. The center line M is a line passing through a center between the second penetration wiring 14 of the first coil 110A and the first penetration wiring 13 of the second coil 110B when viewed in an axis AX direction of the first coil 110A. To be more specific, the first penetration wiring 13 of the first coil 110A and the second penetration wiring 14 of the second coil 110B are linearly symmetric with respect to the center line M, and the second penetration wiring 14 of the first coil 110A and the first penetration wiring 13 of the second coil 110B are linearly symmetric with respect to the center line M. This enables the first coil 110A and the second coil 110B having similar characteristics to be easily obtained.

Preferably, as illustrated in FIG. 6C, the axis AX of the first coil 110A and the axis AX of the second coil 110B are arranged parallel to each other. When viewed in the axis AX direction of the first coil 110A, the second penetration wiring 14 of the first coil 110A and the first penetration wiring 13 of the second coil 110B are adjacent to each other, and the second penetration wiring 14 of the first coil 110A and the first penetration wiring 13 of the second coil 110B are arranged parallel to each other. This enables a distance between the first coil 110A and the second coil 110B adjacent to each other to be decreased such that it is possible to decrease the size the inductor component 1C, since the second penetration wiring 14 of the first coil 110A and the first penetration wiring 13 of the second coil 110B are arranged parallel to each other.

Preferably, as illustrated in FIG. 6C, the axis AX of the first coil 110A and the axis AX of the second coil 110B are arranged parallel to each other. When viewed in the axis AX direction of the first coil 110A, the second penetration wiring 14 of the first coil 110A and the first penetration wiring 13 of the second coil 110B are adjacent to each other, and the second penetration wiring 14 of the first coil 110A and the first penetration wiring 13 of the second coil 110B are arranged parallel to each other. In the first coil 110A, the first penetration wiring 13 and the second penetration wiring 14 are not linearly symmetric with respect to the straight line L1 orthogonal to the bottom surface 100b and including the axis AX when viewed in the axis AX direction.

According to the configuration described above, it is possible to decrease a distance between the first coil 110A and the second coil 110B adjacent to each other such that it is possible to decrease the size the inductor component 1C, since the second penetration wiring 14 of the first coil 110A and the first penetration wiring 13 of the second coil 110B are arranged parallel to each other. In addition, since, in the first coil 110A, the first penetration wirings 13 and the second penetration wirings 14 are not linearly symmetric with respect to the straight line L1 orthogonal to the bottom surface 100b and including the axis AX when viewed in the axis AX direction, it is possible to further improve the degree of freedom in designing the first penetration wirings 13 and the second penetration wirings 14. Similarly, in the second coil 110B, the first penetration wirings 13 and the second penetration wirings 14 may not be linearly symmetric with respect to the straight line L1 orthogonal to the bottom surface 100b and including the axis AX when viewed in the axis AX direction.

### Fourth Modification Example

FIG. 6D is a view showing a fourth modification example of the inductor component, and the view corresponds to the cross section taken along line II-II in FIG. 1. As shown in FIG. 6D, in an inductor component 1D of the fourth modification example, the coil includes a first coil 110A and a second coil 110B as compared with the inductor component 1A shown in FIG. 6A.

In the first coil 110A, the first penetration wiring 13 and the second penetration wiring 14 are not parallel to each other when viewed in the axis AX direction. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1A in FIG. 6A. Meanwhile, the second penetration wiring 14 has a linear shape parallel to the Z direction. That is, the first penetration wiring 13 is bent at a center thereof in the Z direction such that a space between the first penetration wiring 13 and the second penetration wiring 14 is widened toward the center. The first penetration wiring 13 has an arc shape in the Z direction. According to the configuration described above, the side surface of the first penetration wiring 13 can be made smooth such that it is possible to decrease the DC resistance of the first penetration wiring 13.

In the second coil 110B, the first penetration wiring 13 and the second penetration wiring 14 are not parallel to each other when viewed in the axis AX direction. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1A in FIG. 6A. Meanwhile, the first penetration wiring 13 has a linear shape parallel to the Z direction. That is, the second penetration wiring 14 is bent at a center thereof in the Z direction such that a space between the first penetration wiring 13 and the second penetration wiring 14 is widened toward the center. The second penetration wiring 14 has an arc shape in the Z direction. According to the configuration described above, the side surface of the second penetration wiring 14 can be made smooth such that it is possible to decrease the DC resistance of the second penetration wiring 14.

Preferably, as illustrated in FIG. 6D, the axis AX of the first coil 110A and the axis AX of the second coil 110B are arranged parallel to each other. When viewed in the axis AX direction of the first coil 110A, the first penetration wiring 13 and the second penetration wiring 14 of the first coil 110A and the first penetration wiring 13 and the second penetration wiring 14 of the second coil 110B are linearly symmetric with respect to a center line M between the first coil 110A and the second coil 110B. To be more specific, the first penetration wiring 13 of the first coil 110A and the second penetration wiring 14 of the second coil 110B are linearly symmetric with respect to the center line M, and the second penetration wiring 14 of the first coil 110A and the first penetration wiring 13 of the second coil 110B are linearly symmetric with respect to the center line M. This enables the first coil 110A and the second coil 110B having similar characteristics to be easily obtained.

Preferably, as illustrated in FIG. 6D, the axis AX of the first coil 110A and the axis AX of the second coil 110B are arranged parallel to each other. When viewed in the axis AX direction of the first coil 110A, the second penetration wiring 14 of the first coil 110A and the first penetration wiring 13 of the second coil 110B are adjacent to each other, and the second penetration wiring 14 of the first coil 110A and the first penetration wiring 13 of the second coil 110B are arranged parallel to each other. This enables a distance between the first coil 110A and the second coil 110B adjacent to each other to be decreased such that it is possible to decrease the size the inductor component 1D, since the second penetration wiring 14 of the first coil 110A and the first penetration wiring 13 of the second coil 110B are arranged parallel to each other.

Preferably, as illustrated in FIG. 6D, the axis AX of the first coil 110A and the axis AX of the second coil 110B are arranged parallel to each other. When viewed in the axis AX direction of the first coil 110A, the second penetration wiring 14 of the first coil 110A and the first penetration wiring 13 of the second coil 110B are adjacent to each other, and the second penetration wiring 14 of the first coil 110A and the first penetration wiring 13 of the second coil 110B are arranged parallel to each other. In the first coil 110A, the first penetration wiring 13 and the second penetration wiring 14 are not linearly symmetric with respect to the straight line L1 orthogonal to the bottom surface 100b and including the axis AX when viewed in the axis AX direction.

According to the configuration described above, it is possible to decrease a distance between the first coil 110A and the second coil 110B adjacent to each other such that it is possible to decrease the size the inductor component 1D, since the second penetration wiring 14 of the first coil 110A and the first penetration wiring 13 of the second coil 110B are arranged parallel to each other. In addition, since, in the first coil 110A, the first penetration wirings 13 and the second penetration wirings 14 are not linearly symmetric with respect to the straight line L1 orthogonal to the bottom surface 100b and including the axis AX when viewed in the axis AX direction, it is possible to further improve the degree of freedom in designing the first penetration wirings 13 and the second penetration wirings 14. Similarly, in the second coil 110B, the first penetration wirings 13 and the second penetration wirings 14 may not be linearly symmetric with respect to the straight line L1 orthogonal to the bottom surface 100b and including the axis AX when viewed in the axis AX direction.

### Fifth Modification Example

FIG. 6E is a view showing a fifth modification example of the inductor component, and the view corresponds to the cross section taken along line II-II in FIG. 1. As shown in FIG. 6E, an inductor component 1E of the fifth modification example includes a first coil 110A and a second coil 110B as compared with the inductor component 1B of the second modification example shown in FIG. 6B.

In the first coil 110A, the first penetration wiring 13 and the second penetration wiring 14 are not parallel to each other when viewed in the axis AX direction. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1B of the second modification example. Meanwhile, the second penetration wiring 14 has a linear shape parallel to the Z direction. That is, the first penetration wiring 13 is inclined such that a space between the first penetration wiring 13 and the second penetration wiring 14 is widened toward the top surface wiring 11t side in the Z direction. According to the configuration described above, the first penetration wirings 13 and the second penetration wirings 14 can be linearly formed and shortened, and the DC resistance of the first penetration wirings 13 and the second penetration wirings 14 can be reduced.

In the second coil 110B, the first penetration wiring 13 and the second penetration wiring 14 are not parallel to each other when viewed in the axis AX direction. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1B of the second modification example. Meanwhile, the first penetration wiring 13 has a linear shape parallel to the Z direction. That is, the second penetration wiring 14 is inclined such that a space between the first penetration wiring 13 and the second penetration wiring 14 is widened toward the top surface wiring 11t side in the Z direction. According to the configuration described above, the first penetration wirings 13 and the second penetration wirings 14 can be linearly formed, and the electrical resistance of the first penetration wirings 13 and the second penetration wirings 14 can be reduced.

Preferably, as illustrated in FIG. 6E, the axis AX of the first coil 110A and the axis AX of the second coil 110B are arranged parallel to each other. When viewed in the axis AX direction of the first coil 110A, the first penetration wiring 13 and the second penetration wiring 14 of the first coil 110A and the first penetration wiring 13 and the second penetration wiring 14 of the second coil 110B are linearly symmetric with respect to a center line M between the first coil 110A and the second coil 110B. To be more specific, the first penetration wiring 13 of the first coil 110A and the second penetration wiring 14 of the second coil 110B are linearly symmetric with respect to the center line M, and the second penetration wiring 14 of the first coil 110A and the first penetration wiring 13 of the second coil 110B are linearly symmetric with respect to the center line M. This enables the first coil 110A and the second coil 110B having similar characteristics to be easily obtained.

Preferably, as illustrated in FIG. 6E, the axis AX of the first coil 110A and the axis AX of the second coil 110B are arranged parallel to each other. When viewed in the axis AX direction of the first coil 110A, the second penetration wiring 14 of the first coil 110A and the first penetration wiring 13 of the second coil 110B are adjacent to each other, and the second penetration wiring 14 of the first coil 110A and the first penetration wiring 13 of the second coil 110B are arranged parallel to each other. This enables a distance between the first coil 110A and the second coil 110B adjacent to each other to be decreased such that it is possible to decrease the size of the inductor component 1E, since the second penetration wiring 14 of the first coil 110A and the first penetration wiring 13 of the second coil 110B are arranged parallel to each other.

Preferably, as illustrated in FIG. 6E, the axis AX of the first coil 110A and the axis AX of the second coil 110B are arranged parallel to each other. When viewed in the axis AX direction of the first coil 110A, the second penetration wiring 14 of the first coil 110A and the first penetration wiring 13 of the second coil 110B are adjacent to each other, and the second penetration wiring 14 of the first coil 110A and the first penetration wiring 13 of the second coil 110B are arranged parallel to each other. In the first coil 110A, the first penetration wiring 13 and the second penetration wiring 14 are not linearly symmetric with respect to the straight line L1 orthogonal to the bottom surface 100b and including the axis AX when viewed in the axis AX direction.

According to the configuration described above, it is possible to decrease a distance between the first coil 110A and the second coil 110B adjacent to each other such that it is possible to decrease the size the inductor component 1E, since the second penetration wiring 14 of the first coil 110A and the first penetration wiring 13 of the second coil 110B are arranged parallel to each other. In addition, since, in the first coil 110A, the first penetration wirings 13 and the second penetration wirings 14 are not linearly symmetric with respect to the straight line L1 orthogonal to the bottom surface 100b and including the axis AX when viewed in the axis AX direction, it is possible to further improve the degree of freedom in designing the first penetration wirings 13 and the second penetration wirings 14. Similarly, in the second coil 110B, the first penetration wirings 13 and the second penetration wirings 14 may not be linearly symmetric with respect to the straight line L1 orthogonal to the bottom surface 100b and including the axis AX when viewed in the axis AX direction.

### Second Embodiment

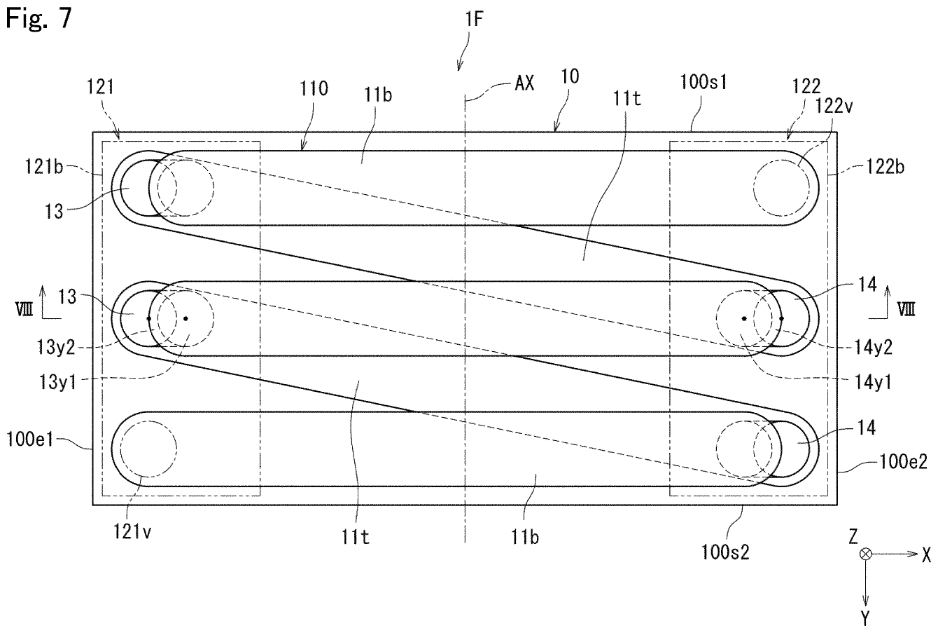

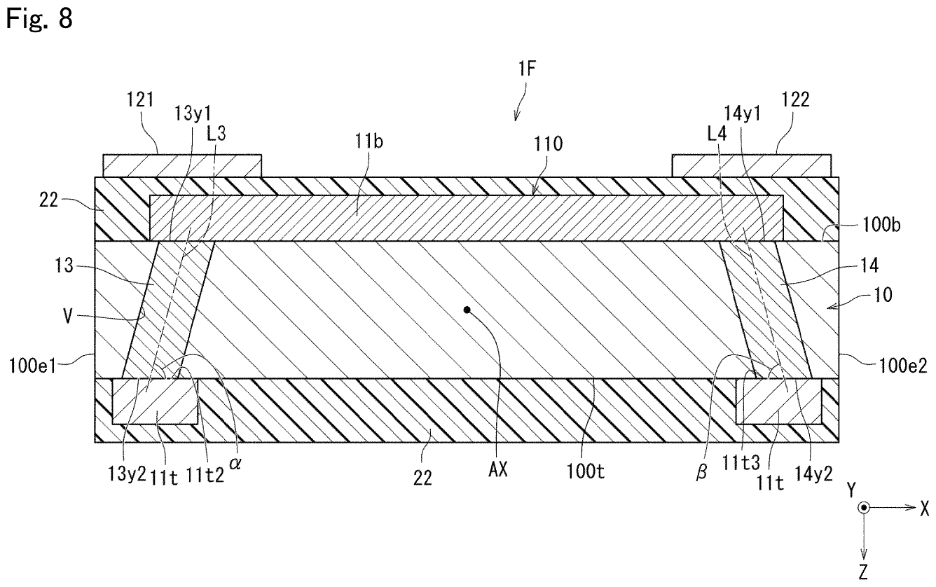

FIG. 7 is a schematic bottom view of a second embodiment of the inductor component from the bottom surface side. FIG. 8 is a cross-sectional view taken along line VIII-VIII in FIG. 7. In FIG. 7, for convenience, an insulating layer is omitted, and the external electrodes are drawn by two-dot chain lines. In addition, in FIG. 7, the element body 10 is drawn transparently so that a structure thereof can be easily understood. The second embodiment differs from the first embodiment mainly in the position of the axis of the coil, the material of the element body, and providing of an insulating layer, and these different configurations will be mainly described below. The other configurations are the same as those of the first embodiment, and the description thereof will be omitted.

### 1. CONFIGURATIONS OF RESPECTIVE UNITS

### (Inductor Component 1F)

As shown in FIG. 7, in an inductor component 1F, an axis AX of a coil 110 is perpendicular to the X direction. To be more specific, the axis AX is parallel to the Y direction and passes a center of the element body 10 in the X direction. This enables interference in magnetic flux of the coil 110 by the first external electrode 121 and the second external electrode 122 to be reduced, and it is possible to improve the efficiency of acquisition of inductance.

A length of the coil 110 in the axis AX direction is shorter than an inner diameter of the coil 110. The length of the coil 110 in the axis AX direction is also referred to as a coil length. This enables the Q value to be improved since the coil length is short and the coil inner diameter is large. The inner diameter of the coil indicates an equivalent circle diameter based on a minimum area of a region surrounded by the coil 110 when viewed therethrough in the axis AX direction.

### (Element Body 10)

The element body 10 is an inorganic insulating body. The material of the element body 10 is preferably glass, and this enables an eddy current to be reduced and enables the Q value to be increased since the glass has high insulation properties. The element body 10 preferably contains an Si element, and this enables the thermal stability of the element body 10 to be increased, thus, enabling variations in dimension or the like of the element body 10 due to heat to be reduced and enabling variations in electrical characteristics to be decreased.

The element body 10 is preferably a single-layer glass plate. This enables the strength of the element body 10 to be ensured. In addition, in the case of the single-layer glass plate, since dielectric loss is small, the Q value at a high frequency can be increased. In addition, since no sintering process for such a sintered body is performed, deformation of the element body 10 during sintering can be reduced. Hence, it is possible to reduce pattern misalignment and provide an inductor component with a small inductance tolerance.

As a material of the single-layer glass plate, a glass plate having photosensitivity represented by Foturan II (Schott AG's registered trademark) is preferable from the viewpoint of a manufacturing method. In particular, the single-layer glass plate preferably contains cerium oxide (ceria: CeO₂), and in this case, cerium oxide serves as a sensitizer, and processing by photolithography becomes easier.

However, since the single-layer glass plate can be processed by machining such as drilling or sandblasting, dry/wet etching using a photoresist/metal mask, laser processing, or the like, the single-layer glass plate may be a non-photosensitive glass plate. In addition, the single-layer glass plate may be obtained by sintering a glass paste, or may be formed by a known method such as a float process.

### (Insulating Body 22)

As shown in FIG. 8, the inductor component 1F includes an insulating body 22. The insulating body 22 covers both the bottom surface 100b and the top surface 100t of the element body 10. Note that the insulating body 22 may be provided only on the bottom surface 100b of the bottom and top surfaces 100b and 1100t.

The insulating body 22 is a member that protects the wirings from an external force by covering the wirings (the bottom surface wirings 11b and the top surface wirings 11t), and has a role of preventing the wirings from being damaged and a role of improving insulation properties of the wirings. The insulating body 22 is preferably an organic insulating body. For example, the insulating body 22 may be a film made of a resin such as epoxy or polyimide which is easily formed. In particular, the insulating body 22 is preferably made of a material having a low dielectric constant. Consequently, in a case where the insulating body 22 is present between the coil 110 and the external electrode 121 or 122, it is possible to decrease the stray capacitance formed between the coil 110 and the external electrode 121 or 122. The insulating body 22 can be formed, for example, by laminating a resin film such as ABF GX-92 (manufactured by Ajinomoto Fine-Techno Co., Inc.), applying and thermal-curing a paste-like resin, or the like. Note that the insulating body 22 may be, for example, an inorganic film made of an oxide such as silicon or hafnium, a nitride, an oxynitride, or the like, which is excellent in insulating properties and thinning.

Preferably, when the element body 10 is the inorganic insulating body, and the insulating body 22 is an organic insulating body, the organic insulating body is positioned on an inner side with respect to the outer surfaces 100 of the inorganic insulating body when viewed in the direction orthogonal to the bottom surface 100b. According to this, since the organic insulating body is provided, the organic insulating body easily imparts flowability, the organic insulating body easily fills a space between wirings adjacent to each other and enables insulating properties to be improved, in a case where the wirings (the bottom surface wirings 11b and the top surface wirings 11t) are covered with the organic insulating body. In addition, since the organic insulating body is not in contact with the outer surface of the inorganic insulating body, it is possible to decrease a load applied to the organic insulating body and reduce deformation and peeling of the organic insulating body when division into individual inductor components is performed.

### (Coil 110)

As shown in FIG. 7, the bottom surface wiring 11b extends only in one direction. To be more specific, the bottom surface wirings 11b have a shape extending in the X direction. All the bottom surface wirings 11b are arranged parallel to each other in the Y direction. The top surface wirings 11t extend only in one direction. To be more specific, the top surface wirings 11t slightly tilt in the Y direction and extend in the X direction. All the top surface wirings 11t are arranged parallel to each other in the Y direction.

As shown in FIGS. 7 and 8, the first penetration wirings 13 are disposed in the through-holes V of the element body 10 on the first end surface 100e1 side with respect to the axis AX, and the second penetration wirings 14 are disposed in the other through-holes V of the element body 10 on the second end surface 100e2 side with respect to the axis AX. Each of the first penetration wirings 13 and the second penetration wirings 14 extends in a direction orthogonal to the bottom surface 100b and the top surface 100t. The plurality of first penetration wirings 13 and the plurality of second penetration wirings 14 are all arranged parallel to each other in the Y direction.

The first penetration wiring 13 and the second penetration wiring 14 are not parallel to each other when viewed in the axis AX direction. To be more specific, the first penetration wirings 13 and the second penetration wirings 14 are inclined such that a space therebetween is widened toward the top surface wiring 11t side in the Z direction. Each of the first penetration wirings 13 and the second penetration wirings 14 has a shape expanding outward in the radial direction of the coil 110 toward the top surface wiring 11t in the Z direction. The coil 110 has a trapezoidal shape when viewed from the axis AX direction. According to the configuration described above, the first penetration wirings 13 and the second penetration wirings 14 can be linearly formed and shortened, and the DC resistance of the first penetration wirings 13 and the second penetration wirings 14 can be reduced.

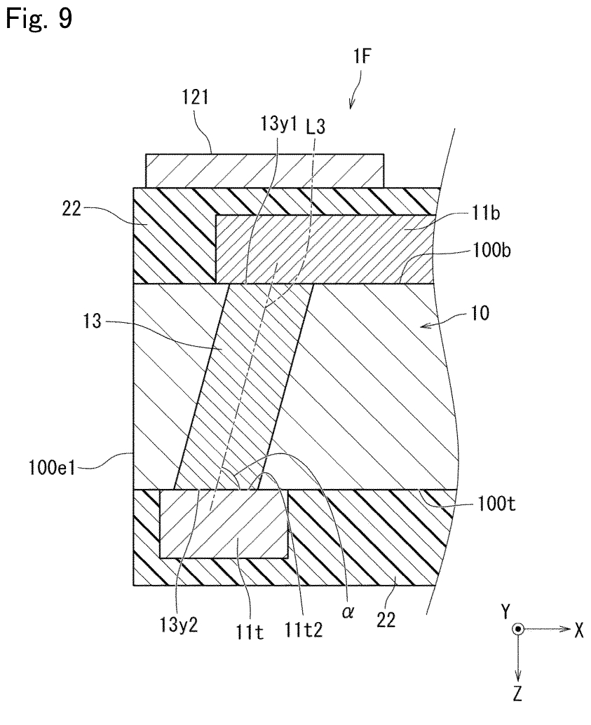

FIG. 9 is a partially enlarged view of FIG. 8. As shown in FIGS. 7, 8, and 9, the first penetration wiring 13 has a first connection surface 13y1 connected to the bottom surface wiring 11b and a second connection surface 13y2 connected to the top surface wiring 11t. The first external electrode 121 is provided on the bottom surface 100b side, and the first external electrode 121 overlaps at least a part of the first connection surface 13y1 when viewed in the direction orthogonal to the bottom surface 100b. When viewed in the axis AX direction, an inclination angle α on the axis AX side formed by a straight line L3 connecting a center of the first connection surface 13y1 and a center of the second connection surface 13y2 and a connection surface 11t2 of the top surface wiring 11t connected to the first penetration wiring 13 is 60° or larger and smaller than 90° (i.e., from is 60° to smaller than 90°).

According to the configuration described above, since the inclination angle α is smaller than 90°, it is possible to decrease an area of the bottom surface wiring 11b overlapping the first external electrode 121 when viewed in the direction orthogonal to the bottom surface 100b. Consequently, it is possible to decrease the parasitic capacitance between the first external electrode 121 and the bottom surface wirings 11b such that it is possible to increase the self-resonant frequency. In addition, since the inclination angle α is 60° or larger, it is possible to secure the inner diameter of the coil 110 such that it is possible to secure the Q value.

Similarly, the second penetration wiring 14 has a first connection surface 14y1 connected to the bottom surface wiring 11b and a second connection surface 14y2 connected to the top surface wiring 11t. The second external electrode 122 is provided on the bottom surface 100b side, and the second external electrode 122 overlaps at least a part of the first connection surface 14y1 when viewed in the direction orthogonal to the bottom surface 100b. In this case, when viewed in the axis AX direction, the inclination angle β on the axis AX side formed by a straight line L4 connecting a center of the first connection surface 14y1 and a center of the second connection surface 14y2 and a connection surface 11t3 of the top surface wiring 11t connected to the second penetration wiring 14 may be 60° or larger and smaller than 90° (i.e., from 60° to smaller than 90°).

According to the configuration described above, since the inclination angle β is smaller than 90°, it is possible to decrease an area of the bottom surface wiring 11b overlapping the second external electrode 122 when viewed in the direction orthogonal to the bottom surface 100b. Consequently, it is possible to decrease the parasitic capacitance between the second external electrode 122 and the bottom surface wirings 11b such that it is possible to increase the self-resonant frequency. In addition, since the inclination angle β is 60° or larger, it is possible to secure the inner diameter of the coil 110 such that it is possible to secure the Q value.

Preferably, as shown in FIG. 7, in the first penetration wiring 13, a part of the first connection surface 13y1 and a part of the second connection surface 13y2 overlap each other when viewed in the direction orthogonal to the bottom surface 100b. This allows the seed layer to be easily formed, in a case where the through-hole Vis formed in the element body 10, the seed layer is provided on the inner surface of the through-hole V, and the first penetration wiring 13 is formed on the seed layer by electrolytic plating. Similarly, in the second penetration wiring 14, a part of the first connection surface 14y1 and a part of the second connection surface 14y2 overlap each other when viewed in the direction orthogonal to the bottom surface 100b.

Preferably, as shown in FIG. 7, in the first penetration wiring 13, a center of the first connection surface 13y1 is closer to the axis AX than a center of the second connection surface 13y2 is when viewed in the direction orthogonal to the bottom surface 100b. This allows the first connection surface 13y1 to be disposed on an inner side of the coil 110 with respect to the second connection surface 13y2 when viewed in the direction orthogonal to the bottom surface 100b. Consequently, it is possible to decrease the area of the bottom surface wiring 11b overlapping the first external electrode 121 when viewed in the direction orthogonal to the bottom surface 100b, and it is possible to decrease the parasitic capacitance between the first external electrode 121 and the bottom surface wiring 11b such that it is possible to increase the self-resonant frequency. Similarly, in the second penetration wiring 14, a center of the first connection surface 14y1 may be closer to the axis AX than a center of the second connection surface 14y2 may when viewed in the direction orthogonal to the bottom surface 100b.

### (Method for Manufacturing Inductor Component 1F)

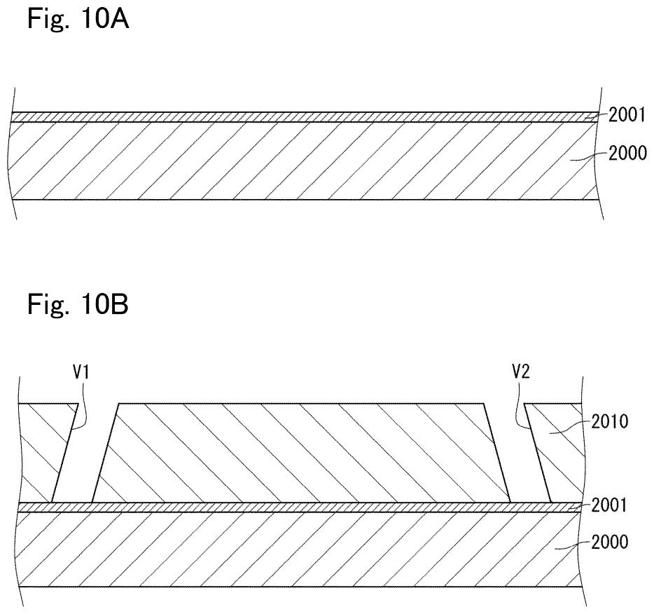

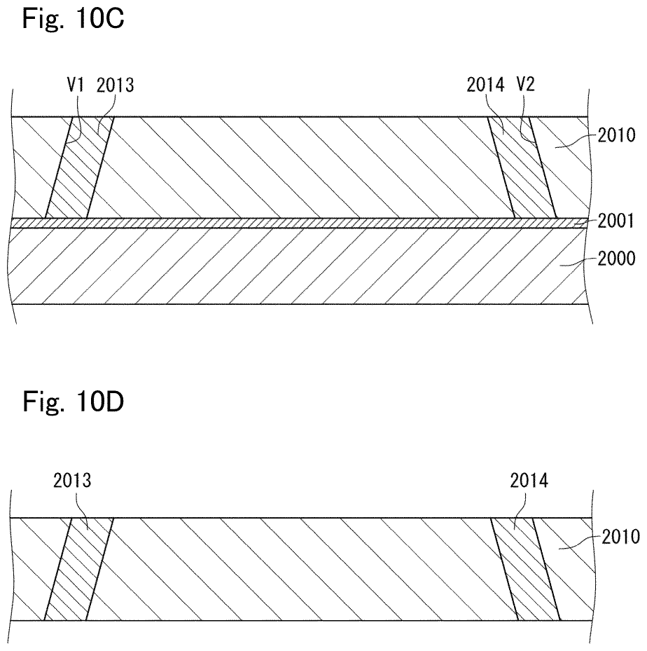

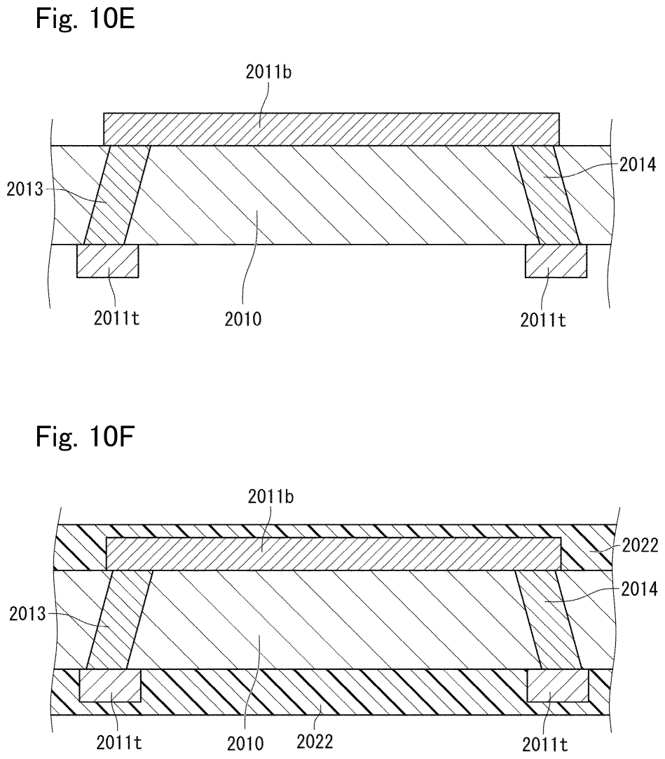

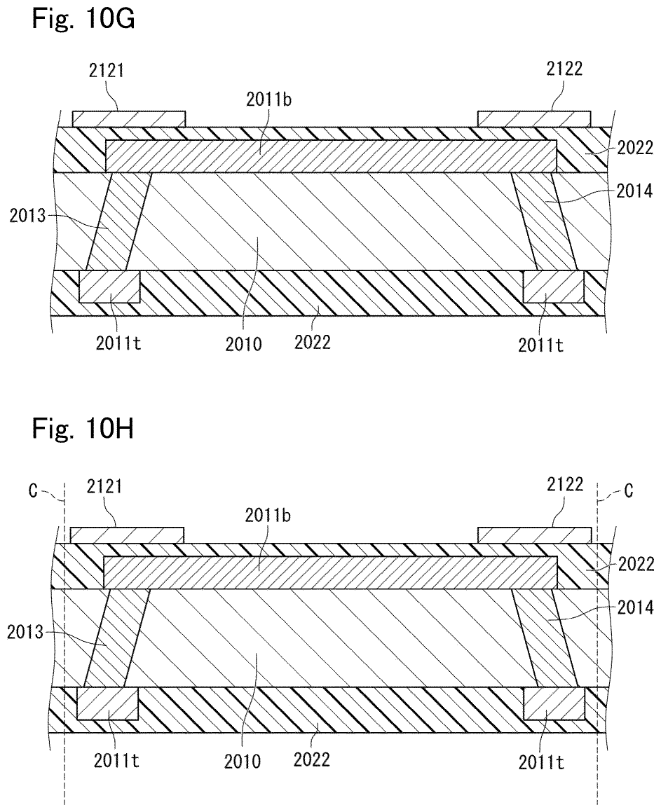

Next, a method for manufacturing the inductor component 1F will be described with reference to FIGS. 10A to 10H. FIGS. 10A to 10H are views corresponding to a cross section taken along line VIII-VIII in FIG. 7.

As shown in FIG. 10A, copper foil 2001 is printed on a base substrate 2000. A material of the base substrate 2000 is the same as that of the base substrate 1000 of the first embodiment.

As shown in FIG. 10B, a glass substrate 2010 which becomes the element body 10 is provided on the base substrate 2000. For example, the base substrate 2000 and the glass substrate 2010 are brought into close contact with each other using a jig such as a conductive tape, a pin, or a frame. The glass substrate 2010 has a first through-hole V1 and a second through-hole V2. The first through-hole V1 and the second through-hole V2 are not parallel to each other. The glass substrate 2010 is, for example, a through glass via (TGV) substrate. The TGV substrate is a substrate in which a through-hole is formed in advance by a laser, photolithography, or the like. The glass substrate 2010 may be, for example, a through silicon via (TSV) substrate, or may be another substrate. In addition, Ti/Cu or other necessary conductive materials may be deposited on a surface of the glass substrate 2010 in advance as seeds by sputtering or the like.

As shown in FIG. 10C, a first penetration conductor layer 2013 which becomes the first penetration wiring 13 is formed in the first through-hole V1. A second penetration conductor layer which becomes the second penetration wiring 14 is formed in the second through-hole V2. To be more specific, by supplying electric power from the copper foil 2001 on the base substrate 2000, electrolytic plating is performed in the first through-hole V1 to form the first penetration conductor layer 2013, and electrolytic plating is performed in the second through-hole V2 to form a second penetration conductor layer 2014. Otherwise, a seed layer may be formed on the surface of the glass substrate 2010 or an inner surface of the through-hole V1 or V2 by sputtering or the like, and the penetration conductor layer may be formed by using a known method such as fill plating, conformal plating, or a printing filling method of a conductive paste. In a case where there is unnecessary plating growth on the surface of the glass substrate 2010, an unnecessary part is removed by polishing, CMP, wet etching (etchback), or dry etching.

As shown in FIG. 10D, the base substrate 2000 is peeled off from the glass substrate 2010. In this case, the base substrate 2000 may be mechanically removed by grinding or the like, or may be chemically removed by etching or the like.

As shown in FIG. 10E, a bottom surface conductor layer 2011b which becomes the bottom surface wiring 11b and a top surface conductor layer 2011t which becomes the top surface wiring 11t are formed on the glass substrate 2010. To be more specific, a seed layer (not shown) is provided on the entire surface of the glass substrate 2010, and patterned photoresist is formed on the seed layer. A copper layer is formed on the seed layer in an opening portion of the photoresist by electrolytic plating. The photoresist and the seed layer are removed by wet etching or dry etching. Consequently, the bottom surface conductor layer 2011b and the top surface conductor layer 2011t patterned in an arbitrary shape are formed. In this case, the bottom surface conductor layer 2011b and the top surface conductor layer 2011t may be formed one by one, or may be formed simultaneously.

As shown in FIG. 10F, an insulating layer 2022 serving as the insulating body 22 is provided on a top surface and a bottom surface of the glass substrate 2010 to cover the conductor layer. In this case, the insulating layer 2022 on the bottom surface side and the insulating layer 2022 on the top surface side may be formed one by one, or may be formed simultaneously. Thereafter, a hole 2022a is formed in the bottom surface conductor layer 2011b of the insulating layer 2022 on the bottom surface side by photolithography or laser processing.

As shown in FIG. 10G, a first external electrode conductor layer 2121 which becomes the first external electrode 121 is provided on the insulating layer 2022 on the bottom surface side. In this case, the first external electrode conductor layer 2121 is connected to the bottom surface conductor layer 2011b. To be more specific, a Pd catalyst (not shown) is provided on the insulating layer 2022 on the bottom surface side, and an Ni/Au plated layer is formed by electroless plating. Patterned photoresist is formed on the plating layer. A plating layer in an opening portion of the photoresist is removed by wet etching or dry etching. Consequently, the first external electrode conductor layer 2121 patterned in an arbitrary shape is formed. Alternatively, a seed layer (not shown) is provided on the insulating layer 2022 on the bottom surface side, and the patterned photoresist is formed on the seed layer. Next, the seed layer in the opening portion of the photoresist is removed by wet etching or dry etching. An Ni/Au plating layer may be formed on the remaining seed layer by electroless plating. Similarly, a second external electrode conductor layer 2122 which becomes the second external electrode 122 is provided on the insulating layer 2022 on the bottom surface side.

As shown in FIG. 10H, division into individual components is performed along the cutting line C. Consequently, as shown in FIG. 8, the inductor component 1F is manufactured.

### 2. MODIFICATION EXAMPLES

### First Modification Example

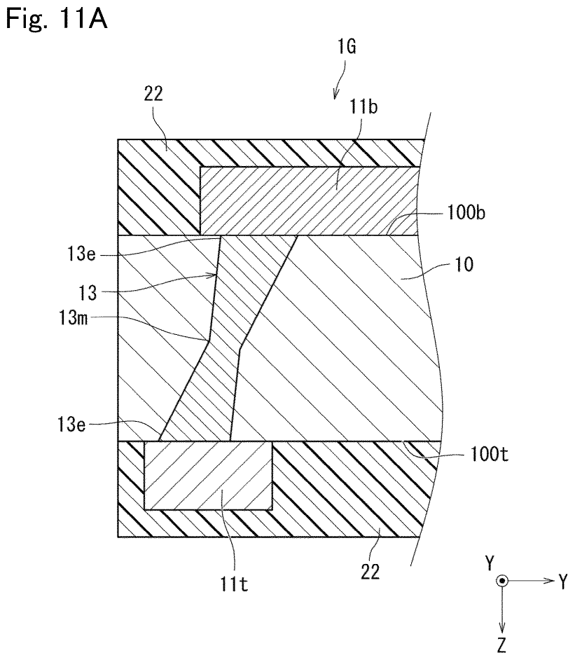

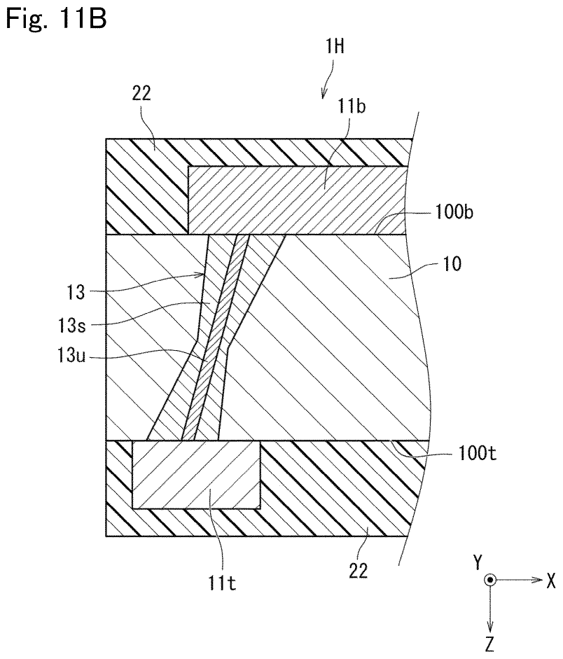

FIG. 11A is a view showing a first modification example of the inductor component, and the view corresponds to a part of a cross section taken along line VIII-VIII in FIG. 7. As shown in FIG. 11A, in an inductor component 1G of the first modification example, a cross-sectional area of each of both end portions 13e of the first penetration wiring 13 in the extending direction thereof is larger than a cross-sectional area of a central portion 13m of the first penetration wiring 13 in the extending direction. The cross-sectional area of the first penetration wiring 13 is an area of a cross section of the first penetration wiring 13 in the direction orthogonal to the bottom surface 100b. On a cross section of the first penetration wiring 13 in the extending direction, a width of the first penetration wiring 13 in the direction orthogonal to the bottom surface 100b is continuously increased from the central portion 13m toward both the end portions 13e.

This enables the cross-sectional area of the end portion 13e of the first penetration wiring 13 to be increased, so that the connectivity between the first penetration wiring 13 and at least one of the bottom surface wiring 11b and the top surface wiring 11t can be improved. In addition, when the through-hole V is formed as a hole portion in the element body 10, the through-hole V is filled with a conductive material by fill plating or the like, and the first penetration wiring 13 is formed in the through-hole V, it is easy to fill the through-hole V on an opening side with the conductive material. Since the cross-sectional area of the end portion 13e of the first penetration wiring 13 is large, and the cross-sectional area of the central portion 13m of the first penetration wiring 13 is small, the first penetration wiring 13 is easily formed.

Note that the cross-sectional area of one end portion 13e of the first penetration wiring 13 may be larger than the cross-sectional area of the central portion 13m of the first penetration wiring 13. Similarly, the cross-sectional area of at least one end portion of the second penetration wiring 14 may be larger than the cross-sectional area of the central portion 13m of the first penetration wiring 13.

### Second Modification Example

FIG. 11B is a view showing a second modification example of the inductor component, and the view corresponds to a part of the cross section taken along line VIII-VIII in FIG. 7. As shown in FIG. 11B, in an inductor component 1H of the second modification example, the first penetration wiring 13 includes a conductive layer 13s positioned on an outer circumferential side thereof when viewed from an extending direction of the first penetration wiring 13, and a non-conductive layer 13u positioned inside the conductive layer 13s. This prevents the Q value from being reduced by providing the conductive layer 13s on the outer circumferential side since a current mainly flows in a surface of the first penetration wiring 13 due to a skin effect in the case of use in a high frequency band. In addition, by providing the non-conductive layer 13u inside, stress can be alleviated, and manufacturing costs can be reduced by using no conductor.

An example of a method of forming the conductive layer 13s and the non-conductive layer 13u will be described. A seed layer is provided on the inner surface of the through-hole V of the element body 10 by sputtering or electroless plating. A plating layer is formed on the seed layer by electrolytic plating. In this manner, for example, a plurality of conductive layers 13s of Ti/Cu/electrolytic Cu, Pd/electroless Cu/electrolytic Cu, or the like can be formed on the first penetration wiring 13 on the outer circumferential side thereof. Thereafter, the inside of the conductive layer 13s is sealed with a resin by printing, hot pressing, or the like to form the non-conductive layer 13u made of a resin. In this manner, stress can be alleviated by the non-conductive layer 13u inside the first penetration wiring 13 while a current flows in the surface (the conductive layer 13s) of the first penetration wiring 13.

Similarly, the second penetration wiring 14 may include a conductive layer positioned on an outer circumferential side thereof when viewed from an extending direction of the second penetration wiring 14, and a non-conductive layer positioned inside the conductive layer. Note that a cross-sectional area of each of both end portions of the first penetration wiring 13 in the extending direction is larger than a cross-sectional area of a central portion of the first penetration wiring 13 in the extending direction, but the cross-sectional area of each of both the end portions of the first penetration wiring 13 in the extending direction may be the same as the cross-sectional area of the central portion of the first penetration wiring 13 in the extending direction.

Note that the present disclosure is not limited to the embodiments described above, and can be modified in design without departing from the gist of the present disclosure. For example, the individual characteristic points of the first and second embodiments may be variously combined.

The present disclosure includes the following aspects.

<1> An inductor component comprising an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order, and the first penetration wirings and the second penetration wirings are not parallel to each other when viewed in the axial direction.

<2 The inductor component according to <1>, in which the first penetration wirings and the second penetration wirings are linearly symmetric with respect to the axis when viewed in a direction orthogonal to the first principal surface.

<3> The inductor component according to <1> or <2>, in which the first penetration wirings and the second penetration wirings are linearly symmetric with respect to a straight line orthogonal to the first principal surface and including the axis when viewed in the axial direction.

<4> The inductor component according to any one of <1> to <3>, in which a line edge roughness of the first penetration wirings is higher than a line edge roughness of the first coil wirings.

<5> The inductor component according to any one of <1> to <3>, in which a line edge roughness of the first penetration wirings is equal to or lower than a line edge roughness of the first coil wirings.

<6> The inductor component according to <1>, in which a width of each of the first penetration wirings is different from a width of each of the second penetration wirings.

<7> The inductor component according to any one of <1> to <6>, in which the first penetration wirings have respective outer circumferential parts positioned on an outer side with respect to the first coil wirings and the second coil wirings in a radial direction of the coil when viewed in the axial direction, and the outer circumferential parts are disposed between 0.3 or more and 0.7 (i.e., from 0.3 to 0.7) or less of a height of the element body with the first principal surface as a reference in the direction orthogonal to the first principal surface.

<8> The inductor component according to any one of <1> to <7>, further comprising a second coil that is provided in the element body and is wound in a spiral shape along a second axis parallel to the axis; and a third external electrode and a fourth external electrode that are provided on the element body and are electrically connected to the second coil. The second coil includes a plurality of third coil wirings which are provided on the first principal surface side with respect to the second axis and are arranged along the second axis on a plane parallel to the first principal surface, a plurality of fourth coil wirings which are provided on the second principal surface side with respect to the second axis and are arranged along the second axis on a plane parallel to the second principal surface, a plurality of third penetration wirings which extend from the respective third coil wirings toward the respective fourth coil wirings and are arranged along the second axis, and a plurality of fourth penetration wirings which extend from the respective third coil wirings toward the respective fourth coil wirings, are provided on a side opposite to the respective third penetration wirings with respect to the second axis, and are arranged along the second axis. Each of the third coil wirings, each of the third penetration wirings, each of the fourth coil wirings, and each of the fourth penetration wirings form at least a part of a spiral shape of the second coil by being connected in this order, and the second penetration wirings and the third penetration wirings are adjacent to each other.

<9> The inductor component according to <8>, in which the first penetration wirings and the second penetration wirings, and the third penetration wirings and the fourth penetration wirings are linearly symmetric with respect to a center line between the coil and the second coil when viewed in the axial direction of the coil.

<10> The inductor component according to <8> or <9>, in which the second penetration wirings and the third penetration wirings are arranged parallel to each other, when viewed in the axial direction of the coil.

<11> The inductor component according to <9>, in which the first penetration wirings and the second penetration wirings are not linearly symmetric with respect to a straight line orthogonal to the first principal surface and including the axis when viewed in the axial direction.

<12> The inductor component according to <8>, in which the third penetration wirings and the fourth penetration wirings are not parallel to each other when viewed in the second axial direction.

<13> The inductor component according to any one of <1> to <12>, in which the first penetration wirings have respective first connection surfaces connected to the respective first coil wirings and respective second connection surfaces connected to the respective second coil wirings, and the first external electrode is provided on the first principal surface side, and overlaps at least a part of each of the first connection surfaces when viewed in the direction orthogonal to the first principal surface. Also, when viewed in the axial direction, an inclination angle on the axial side formed by a straight line connecting a center of each of the first connection surfaces and a center of each of the second connection surfaces and a connection surface of each of the second coil wirings connected to each of the first penetration wirings is 60° or larger and smaller than 90° (i.e., from 60° to smaller than) 90°.

<14> The inductor component according to <13>, in which a part of each of the first connection surfaces and a part of each of the second connection surfaces overlap each other when viewed in the direction orthogonal to the first principal surface.

<15> The inductor component according to <13> or <14>, in which the center of each of the first connection surfaces is closer to the axis than the center of each of the second connection surfaces is when viewed in the direction orthogonal to the first principal surface.

<16> The inductor component according to any one of <1> to <15>, in which each of the first penetration wirings includes a conductive layer positioned on an outer circumferential side when viewed in an extending direction of the first penetration wirings, and a non-conductive layer positioned inside the conductive layer.

<17> The inductor component according to any one of <1> to <16>, in which a cross-sectional area of at least one of both end portions of each of the first penetration wirings in the extending direction is larger than a cross-sectional area of a central portion of each of the first penetration wirings in the extending direction.

<18> The inductor component according to any one of <1> to <17>, in which the inductor component has a thickness of 200 μm or smaller.

<19> The inductor component according to any one of <1> to <18>, in which, when viewed in the direction orthogonal to the first principal surface, the first external electrode and the second external electrode are positioned on an inner side with respect to an outer circumferential surface of the element body.

<20> The inductor component according to any one of <1> to <19>, further including an organic insulating body provided on the first principal surface, in which the element body is an inorganic insulating body, and the organic insulating body is positioned on an inner side with respect to an outer surface of the inorganic insulating body when viewed in the direction orthogonal to the first principal surface.

What is claimed is:

1. An inductor component comprising:
an element body having a first principal surface and a second principal surface opposite to each other;
a coil that is in the element body and is wound in a spiral shape along an axis; and
a first external electrode and a second external electrode that are on the element body and are electrically connected to the coil, wherein
the axis of the coil is parallel to the first principal surface,
the coil includes
a plurality of first coil wirings which are on the first principal surface side with respect to the axis and are arranged along the axis on a plane parallel to the first principal surface,
a plurality of second coil wirings which are on the second principal surface side with respect to the axis and are arranged along the axis on a plane parallel to the second principal surface,
a plurality of first penetration wirings which extend from the respective first coil wirings toward the respective second coil wirings and are arranged along the axis, and
a plurality of second penetration wirings which extend from the respective first coil wirings toward the respective second coil wirings, are on a side opposite to the respective first penetration wirings with respect to the axis, and are arranged along the axis,
each of the first coil wirings, each of the first penetration wirings, each of the second coil wirings, and each of the second penetration wirings configure at least a part of the spiral shape by being connected in this order, and
the first penetration wirings and the second penetration wirings are not parallel to each other when viewed in the axial direction.

2. The inductor component according to claim 1, wherein
the first penetration wirings and the second penetration wirings are linearly symmetric with respect to the axis when viewed in a direction orthogonal to the first principal surface.

3. The inductor component according to claim 1, wherein
the first penetration wirings and the second penetration wirings are linearly symmetric with respect to a straight line orthogonal to the first principal surface and including the axis when viewed in the axial direction.

4. The inductor component according to claim 1, wherein
a line edge roughness of the first penetration wirings is higher than a line edge roughness of the first coil wirings.

5. The inductor component according to claim 1, wherein
a line edge roughness of the first penetration wirings is equal to or lower than a line edge roughness of the first coil wirings.

6. The inductor component according to claim 1, wherein
a width of each of the first penetration wirings is different from a width of each of the second penetration wirings.

7. The inductor component according to claim 1, wherein
the first penetration wirings have respective outer circumferential parts positioned on an outer side with respect to the first coil wirings and the second coil wirings in a radial direction of the coil when viewed in the axial direction, and
the outer circumferential parts are disposed between from 0.3 to 0.7 of a height of the element body with the first principal surface as a reference in the direction orthogonal to the first principal surface.

8. The inductor component according to claim 1, further comprising:
a second coil that is in the element body and is wound in a spiral shape along a second axis parallel to the axis; and
a third external electrode and a fourth external electrode that are on the element body and are electrically connected to the second coil, wherein
the second coil includes
a plurality of third coil wirings which are on the first principal surface side with respect to the second axis and are arranged along the second axis on a plane parallel to the first principal surface,
a plurality of fourth coil wirings which are on the second principal surface side with respect to the second axis and are arranged along the second axis on a plane parallel to the second principal surface,
a plurality of third penetration wirings which extend from the respective third coil wirings toward the respective fourth coil wirings and are arranged along the second axis, and
a plurality of fourth penetration wirings which extend from the respective third coil wirings toward the respective fourth coil wirings, are on a side opposite to the respective third penetration wirings with respect to the second axis, and are arranged along the second axis,
each of the third coil wirings, each of the third penetration wirings, each of the fourth coil wirings, and each of the fourth penetration wirings configure at least a part of a spiral shape of the second coil by being connected in this order, and
the second penetration wirings and the third penetration wirings are adjacent to each other.

9. The inductor component according to claim 8, wherein
the first penetration wirings and the second penetration wirings, and the third penetration wirings and the fourth penetration wirings are linearly symmetric with respect to a center line between the coil and the second coil when viewed in the axial direction of the coil.

10. The inductor component according to claim 8, wherein
the second penetration wirings and the third penetration wirings are parallel to each other, when viewed in the axial direction of the coil.

11. The inductor component according to claim 9, wherein
the first penetration wirings and the second penetration wirings are not linearly symmetric with respect to a straight line orthogonal to the first principal surface and including the axis when viewed in the axial direction.

12. The inductor component according to claim 8, wherein
the third penetration wirings and the fourth penetration wirings are not parallel to each other when viewed in the second axial direction.

13. The inductor component according to claim 1, wherein
the first penetration wirings have respective first connection surfaces connected to the respective first coil wirings and respective second connection surfaces connected to the respective second coil wirings,
the first external electrode is on the first principal surface side, and overlaps at least a part of each of the first connection surfaces when viewed in the direction orthogonal to the first principal surface, and
when viewed in the axial direction, an inclination angle on the axial side defined by a straight line connecting a center of each of the first connection surfaces and a center of each of the second connection surfaces and a connection surface of each of the second coil wirings connected to each of the first penetration wirings is from 60° to smaller than 90°.

14. The inductor component according to claim 13, wherein
a part of each of the first connection surfaces and a part of each of the second connection surfaces overlap each other when viewed in the direction orthogonal to the first principal surface.

15. The inductor component according to claim 13, wherein
the center of each of the first connection surfaces is closer to the axis than the center of each of the second connection surfaces is when viewed in the direction orthogonal to the first principal surface.

16. The inductor component according to claim 1, wherein
each of the first penetration wirings includes a conductive layer positioned on an outer circumferential side when viewed in an extending direction of the first penetration wirings, and a non-conductive layer positioned inside the conductive layer.

17. The inductor component according to claim 1, wherein
a cross-sectional area of at least one of both end portions of each of the first penetration wirings in the extending direction is larger than a cross-sectional area of a central portion of each of the first penetration wirings in the extending direction.

18. The inductor component according to claim 1, wherein
the inductor component has a thickness of 200 μm or smaller.

19. The inductor component according to claim 1 wherein
when viewed in the direction orthogonal to the first principal surface, the first external electrode and the second external electrode are positioned on an inner side with respect to an outer circumferential surface of the element body.

20. The inductor component according to claim 1, further comprising:
an organic insulating body on the first principal surface, wherein
the element body is an inorganic insulating body, and the organic insulating body is positioned on an inner side with respect to an outer surface of the inorganic insulating body when viewed in the direction orthogonal to the first principal surface.
